(19) United States
(12) Patent Application Publication
(10) Pub. No.: US 2026/0049811 A1
(43) Pub. Date: Feb. 19, 2026

(54) METHOD FOR MEASURING THERMAL SHRINKAGE RATE OF POLYESTER SHRINK FILM

(71) Applicants: C.I. TAKIRON Corporation, Osaka (JP); Bonset America Corporation, Browns Summit, NC (US)

(72) Inventors: Takuma KANEKO, Osaka (JP); Shuta YUGE, Osaka (JP); Tatsuya IRIFUNE, Osaka (JP); Ryuma UMINO, Osaka (JP)

(21) Appl. No.: 19/333,347

(22) Filed: Sep. 19, 2025

Related U.S. Application Data
(63) Continuation of application No. PCT/JP2024/012580, filed on Mar. 28, 2024.

(30) Foreign Application Priority Data
Mar. 29, 2023 (JP) 2023-053384

(51) Int. Cl. G01B 11/03; G01B 11/04; G01B 11/16

(52) U.S. Cl. CPC G01B 11/03; G01B 11/043; G01B 11/16

(57) ABSTRACT

It is a method for measuring a heat shrinkage ratio of a heat-shrinkable polyester film by using a motion capture device, the method including the following steps (a) to (e). That is, the method includes: step (a) of setting two measurement positions in a main shrinkage direction, and measuring an interval between the two measurement positions as L1; step (b) of attaching markers of an inertial measurement device to the measurement positions; step (c) of heating the film at a predetermined temperature for a predetermined time as predetermined heat shrinkage conditions to cause the film to undergo heat shrinkage; step (d) of measuring the interval between the two measurement positions after heat shrinkage as L′1 by using a motion capture device; and step (e) of calculating a heat shrinkage ratio of the heat-shrinkable polyester film based on a predetermined formula.

### CROSS-REFERENCE TO RELATED APPLICATIONS

This Application claims the benefit of priority and is a Continuation application of the prior International Patent Application No. PCT/JP2024/012580, with an international filing date of Mar. 28, 2024, which designated the United States, and is related to the Japanese Patent Application No. 2023-053384, filed Mar. 29, 2023, the entire disclosures of all applications are expressly incorporated by reference in their entirety herein.

### TECHNICAL FIELD

The present invention relates to a method for measuring a heat shrinkage ratio of a heat-shrinkable polyester film (sometimes called as a polyester-based shrink film or the like).

More particularly, the invention relates to a method for measuring a heat shrinkage ratio of a heat-shrinkable polyester film, by which the heat shrinkage ratio can be measured quickly and accurately by using a motion capture device.

### BACKGROUND ART

Conventionally, heat-shrinkable films have been widely used as base material films for labels on PET bottles and the like. In particular, polyester resins have excellent transparency and strength and are widely used. These heat-shrinkable films are caused to undergo heat shrinkage by passing through a tunnel that generates hot air or steam, and are fitted on containers; however, shrinkage differences (unevenness) would occur during heat shrinkage, causing the occurrence of wrinkles and color unevenness.

Thus, various heat-shrinkable polyester films for preventing the occurrence of wrinkles and the occurrence of color unevenness due to shrinkage differences (unevenness) produced during heat shrinkage, have been proposed.

For example, a heat-shrinkable polyester film obtained by controlling the proportion of alcohol components other than ethylene glycol, or strictly controlling the amount of a naphthalenedicarboxylic acid component in all acid components or the blending amount of an alkali metal salt of sulfobenzenedicarboxylic acid, has been proposed (see Patent Document 1).

More specifically, the heat-shrinkable polyester film is characterized in that the proportion (A mol %) of acid components other than terephthalic acid in all acid components of the polyester resin and the proportion (B mol %) of alcohol components other than ethylene glycol in all alcohol components of the polyester resin are in the range of 5 mol %≤A+B≤40 mol %, and the polyester resin contains 1 mol % to 30 mol % of a naphthalenedicarboxylic acid component, and 0.3 mol % to 3 mol % of an alkali metal salt of sulfobenzenedicarboxylic acid in all the acid components.

It is configured that the heat shrinkage ratio of such a polyester film is preferably 5% or more in the longitudinal direction of the film when immersed in hot water at a temperature of 60° C. for a time of 60 seconds, and is preferably 30% or more when immersed in hot water at a temperature of 80° C. for a time of 60 seconds.

Furthermore, a heat-shrinkable polyester film has been proposed, in which the blending amount of an amorphous component in all polyester resin components is strictly controlled, and at the same time, the hot water heat shrinkage ratios at 80° C. and 90° C. in the film longitudinal direction and the hot water heat shrinkage ratio at 90° C. in the film width direction are limited (see Patent Document 2).

More specifically, it is a heat-shrinkable polyester film which contains ethylene terephthalate as a main constituent component and contains one or more monomer components that would become amorphous components in all the polyester resin components, the total sum of which is 15 mol % or more.

Then, the polyester film is characterized in that the hot water heat shrinkage ratio in the film longitudinal direction is 30% or more at a treatment temperature of 80° C. for a treatment time of 10 seconds and is 40% or more at a treatment temperature of 90° C. for a treatment time of 10 seconds, and the hot water shrinkage ratio in the film width direction is 10% or less at 90° C. for a treatment time of 10 seconds.

Furthermore, a heat-shrinkable polyester film has been proposed, in which the shrinkage ratio in one direction and heat shrinkage ratio in a direction perpendicular thereto are specified, and at the same time, the average heat shrinkage rate coefficient in a temperature range of 70° C. to 120° C. is within a predetermined range (see Patent Document 3).

More specifically, it is a heat-shrinkable polyester film, which is a homopolymer of polyethylene terephthalate, or a copolymer configured to contain a dicarboxylic acid component other than terephthalic acid, and/or a diol component other than ethylene glycol, and/or an oxycarboxylic acid and the like.

The heat-shrinkable polyester film is characterized in that the heat shrinkage ratio in at least one direction is 30% or more, and the average heat shrinkage rate coefficient at least in that direction in a temperature range of 70° C. to 120° C. is within the range of 0.1 to 0.5%/sec·° C.

Furthermore, a shrink label has been proposed, in which the maximum heat shrinkage rate measured under predetermined conditions is specified (see Patent Document 4).

More specifically, it is a heat-shrinkable shrink label, which has at least one film layer containing a polylactic acid polymer as an essential component, and a print layer.

The film is characterized in that the heat shrinkage ratio in the main orientation direction after 1 second from the start of heat shrinkage in hot water at 75° C. is 3% to 23%, and the heat shrinkage ratio in the main orientation direction at 90° C. for 10 seconds is 40% to 84%.

Alternatively, the film is characterized in that the maximum heat shrinkage rate in the main orientation direction in hot water at 70° C. is 7 to 40%/sec, and the heat shrinkage ratio in the main orientation direction at 90° C. for 10 seconds is 40% to 84%.

### CITATION LIST

### Patent Document

Patent Document 1: JP 08-027259 A (claims and the like)
Patent Document 2: JP 2007-016120 A (claims and the like)
Patent Document 3: JP 08-323859 A (claims and the like)
Patent Document 4: JP 2008-001098 A (claims and the like)

### DISCLOSURE OF THE INVENTION

### Problem to be Solved by the Invention

However, with regard to the heat-shrinkable films described in Patent Documents 1 and 2, although the heat shrinkage ratio at a predetermined temperature in a predetermined shrinkage direction is limited to be within a predetermined range, after the film is immersed in hot water, it is necessary to remove the film from the hot water and make measurement, so that uneven heat distribution and the like are likely to occur, and the variations in the measured values would become large.

Therefore, it is difficult to obtain a polyester film having a desired heat shrinkage ratio from a polyester film having a heat shrinkage ratio measured in this way, and there are cases in which the heat shrinkage ratio characteristics would not be managed quickly and precisely.

Therefore, in particular, in the case of PET bottles and the like having a complex shape, in which the bottle diameter of the body part is not uniform, and the horizontal cross-sectional shape of the body part is not circular in some parts, since the heat shrinking property is likely to be non-uniform, there is a problem that it is extremely difficult to suppress the occurrence of fine wrinkles.

Furthermore, with regard to the heat-shrinkable film described in Patent Document 3, although the amount of change in the heat shrinkage ratio with respect to time is specified, it is intended to specify the heat shrinkage rate coefficient (%/(sec·° C.)) averaged before and after heat shrinkage, and there is no intention of measuring the heat shrinkage rate (mm/sec) from before heat shrinkage until a predetermined time, as well as the maximum value thereof.

For that reason, the heat shrinkage rate (mm/sec) could not be accurately measured at a timing when the heat-shrinkable film undergoes a large change in a short period of time during heat shrinkage.

Furthermore, with regard to the shrink label described in Patent Document 4, although the heat shrinkage ratio (%) after 1 second from the start of heat shrinkage is specified, this heat shrinkage ratio is a time-limited heat shrinkage ratio, and there is no intention given to shrink labels that have different timings for heat shrinkage.

In addition, although the maximum heat shrinkage rate (%/sec) is also mentioned, this is a measurement of the actual instantaneous heat shrinkage rate obtained when measured at an interval of 0.1 seconds, and there is no intention of measuring the maximum value of the heat shrinkage rate (mm/sec) from before heat shrinkage until a predetermined time.

Therefore, when converted to a maximum value of the heat shrinkage rate from before heat shrinkage until a predetermined time, the heat shrinkage rate is limited to a very narrow range.

Thus, the inventors of the present invention found that, by measuring the heat shrinkage ratio in the main shrinkage direction or the like using a motion capture device through predetermined steps (a) to (e), and controlling the value thereof, the heat shrinkage characteristics can be measured quickly and accurately, thus completing the present invention.

That is, it is an object of the present invention to provide, as a simple method, a method for measuring a heat shrinkage ratio of a heat-shrinkable polyester film quickly and accurately by using a predetermined motion capture device.

### Means for Solving Problem

According to the present invention, there is provided a method for measuring a heat shrinkage ratio of a heat-shrinkable polyester film by using a motion capture device, the method including the following steps (a) to (e), and the above-described problems can be solved.

Step (a): A step of setting two measurement positions in a main shrinkage direction of a heat-shrinkable polyester film as an object to be measured, and measuring an interval between the two measurement positions as L1.

Step (b): A step of providing a predetermined marker at each of the two measurement positions.

Step (c): A step of heating the heat-shrinkable polyester film at a predetermined temperature for a predetermined time as predetermined heat shrinkage conditions to cause the film to undergo heat shrinkage.

Step (d): A step of measuring a distance of the predetermined interval after heat shrinkage as L′1 by using a motion capture device.

Step (e): A step of calculating a heat shrinkage ratio in the main shrinkage direction of the heat-shrinkable polyester film based on the following Formula (1) as a heat shrinkage ratio in a TD direction.

$$Heat shrinkage ratio in TD direction ( \% ) = ( L 1 - {L}^{′} 1 ) / L 1 \times 100 \qquad ( 1 )$$

That is to say, by measuring the heat shrinkage ratio at predetermined positions through predetermined steps (a) to (e) using a motion capture device, the heat shrinkage ratio can be measured quickly and accurately by a simple method with little variation.

Upon carrying out the method for measuring a heat shrinkage ratio of a heat-shrinkable polyester film of the present invention, it is preferable that the interval between the two measurement positions in step (a) is set at a plurality of sites, heat shrinkage in the TD direction is calculated at the plurality of sites in steps (d) and (e), and an average value thereof is defined as a heat shrinkage ratio in the TD direction.

By calculating a plurality of heat shrinkage in the TD direction in this way, the heat shrinkage ratio in the TD direction can be measured more quickly and accurately.

Upon carrying out the method for measuring a heat shrinkage ratio of a heat-shrinkable polyester film of the present invention, it is preferable that an image-type motion capture device is used as the motion capture device, and the heat shrinkage ratio in the TD direction is calculated based on positions of the predetermined markers before and after heat shrinkage.

By selecting and using an image-type motion capture device from among various types of motion capture devices in this way, the positions of the predetermined markers could be efficiently calculated, and the heat shrinkage ratio could be measured quickly and accurately.

Upon carrying out the method for measuring a heat shrinkage ratio of a heat-shrinkable polyester film of the present invention, it is preferable that a camera is prepared in step (b), and a state of heat shrinkage of the heat-shrinkable polyester film as an object to be measured is also observed.

By recording camera images as well in this way, the state of heat shrinkage in the TD direction can be checked, and the heat shrinkage ratio in the TD direction can be measured more quickly and accurately.

Upon carrying out the method for measuring a heat shrinkage ratio of a heat-shrinkable polyester film of the present invention, it is preferable that the heat shrinkage temperature in step (c) has a value within a range of 50° C. to 98° C., and the heat shrinkage time has a value within a range of 1 to 60 seconds.

By adopting such heat shrinkage conditions, the results can be compared with the heat shrinkage characteristics at the time of actually using the heat-shrinkable polyester film.

Upon carrying out the method for measuring a heat shrinkage ratio of a heat-shrinkable polyester film of the present invention, it is preferable that the place of heat shrinkage in step (c) is at least one of a constant temperature bath, a steam bath, a hot water bath, a fluorine-containing liquid bath, and an infrared ray irradiating apparatus.

By adopting these various heat shrinkage places, the heat shrinkage ratio can be measured more quickly and accurately and more simply, according to the use applications and the like of the heat-shrinkable polyester film.

Upon carrying out the method for measuring a heat shrinkage ratio of a heat-shrinkable polyester film of the present invention, it is preferable that in step (d), a heat shrinkage ratio in a direction orthogonally intersecting the main shrinkage direction of the heat-shrinkable polyester film as an object to be measured is measured as a heat shrinkage ratio in an MD direction using a motion capture device, simultaneously with measurement of the heat shrinkage ratio in the TD direction.

By simultaneously measuring the heat shrinkage ratio in the MD direction using a motion capture device in this way, the heat shrinkage characteristics can be compared with the heat shrinkage characteristics at the time of actually using the heat-shrinkable polyester film, according to the use applications and the like of the heat-shrinkable polyester film.

Upon carrying out the method for measuring a heat shrinkage ratio of a heat-shrinkable polyester film of the present invention, it is preferable that a step of preparing in advance a calibration curve showing a relation between the heat shrinkage temperature and the heat shrinkage time in the main shrinkage direction of the heat-shrinkable polyester film as an object to be measured, and the heat shrinkage ratio in the TD direction, and comparing and verifying the calibration curve with the heat shrinkage ratio obtained based on Formula (1), is included as step (f), after step (e).

By comparing and verifying the heat shrinkage ratio with a calibration curve prepared in advance in this way, the heat shrinkage ratio can be measured more quickly and accurately, and with higher reproducibility.

### BRIEF DESCRIPTION OF DRAWINGS

FIGS. 1A to 1C are each a drawing for explaining the morphology of a heat-shrinkable polyester film;

FIGS. 2A to 2C are each a drawing for explaining a method for measuring a heat shrinkage ratio of the heat-shrinkable polyester film by using a motion capture device or the like;

FIGS. 3A and 3B are each a drawing for explaining the positional movement of a predetermined marker associated with heat shrinkage of the heat-shrinkable polyester film;

FIGS. 4A and 4B are each a drawing provided to explain a method for measuring a heat shrinkage rate of the heat-shrinkable polyester film by using a motion capture device or the like;

FIGS. 5A to 5C are each a drawing provided to explain a configuration example of a fixing jig used in measuring the heat shrinkage rate using a motion capture device;

FIGS. 6A and 6B are each a drawing provided to explain the heat shrinkage rate, the heat shrinkage ratio rate, and the like;

FIG. 7 is a drawing provided to explain the relation of the distance change (mm) of a predetermined section to time (seconds) in the heat-shrinkable polyester films of Examples 1 and 2 and Comparative Examples 2 and 3;

FIGS. 8A and 8B are each a drawing provided to explain the relation of the heat shrinkage rate (mm/sec) to time (seconds) in the heat-shrinkable polyester films of Examples 1 and 2, and FIG. 8C is a drawing provided to explain the relation of the heat shrinkage ratio rate (%/sec) to time;

FIGS. 9A and 9B are each a drawing provided to explain the relation of the heat shrinkage rate (mm/sec) to time (seconds) in the heat-shrinkable polyester films of Comparative Examples 2 and 3, and FIG. 9C is a drawing provided to explain the relation of the heat shrinkage ratio rate (%/sec) to time;

FIG. 10A is a drawing provided to explain the relation of the intermediate heat shrinkage rate (mm/sec) to time (seconds) in the heat-shrinkable polyester film of Example 1, and FIG. 10B is a drawing provided to explain the relation of the intermediate heat shrinkage ratio rate (%/sec) to time;

FIG. 11A is a drawing provided to explain the relation of the intermediate heat shrinkage rate (mm/sec) to time (seconds) in the heat-shrinkable polyester film of Example 2, and FIG. 11B is a drawing provided to explain the relation of the intermediate heat shrinkage ratio rate (%/sec) to time;

FIG. 12A is a drawing provided to explain the relation of the intermediate heat shrinkage rate (mm/sec) to time (seconds) in the heat-shrinkable polyester film of Comparative Example 2, and FIG. 12B is a drawing provided to explain the relation of the intermediate heat shrinkage ratio rate (%/sec) to time;

FIG. 13A is a drawing provided to explain the relation of the intermediate heat shrinkage rate (mm/sec) to time (seconds) in the heat-shrinkable polyester film of Comparative Example 3, and FIG. 13B is a drawing provided to explain the relation of the intermediate heat shrinkage ratio rate (%/sec) to time;

FIG. 14A is a drawing for explaining a plurality of measurement samples (W, C, and E) collected along the TD direction from a roll-shaped heat-shrinkable polyester film, and FIG. 14B is a drawing provided to explain a state in which a motion capture device is attached to one of the measurement samples (W, C, and E);

FIG. 15 is a drawing provided to explain, for Example 1 (line A) and Comparative Example 1 (line B), the relation between the immersion time when the film is immersed in hot water at 95° C. for 1 to 20 seconds, and the heat shrinkage ratio (%) in the TD direction measured using a motion capture device;

FIG. 16 is a drawing provided to explain the relation between the thickness (μm) of the heat shrinkable polyester film and the heat shrinkage ratio (%) in the TD direction measured using a motion capture device when the film is immersed in hot water at 95° C. for 20 seconds;

FIG. 17A is a drawing (photograph) showing the external appearance state of a cylindrical-shaped label corresponding to Example 1 in a case where no wrinkles have occurred, and FIGS. 17B to 17D are drawings that enlarge regions P, Q, and R, respectively, in the external appearance shown in FIG. 17A; and

FIG. 18A is a drawing (photograph) showing the external appearance state of a cylindrical-shaped label corresponding to Comparative Example 1 in a case where wrinkles have occurred, and FIGS. 18B to 18D are drawings that enlarge regions S, T, and U, respectively, in the external appearance shown in FIG. 18A.

### BEST MODE(S) FOR CARRYING OUT THE INVENTION

### First Embodiment

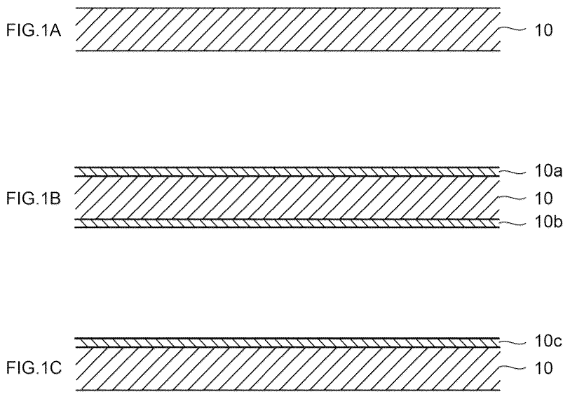

A first embodiment is a method for measuring a heat shrinkage ratio of a heat-shrinkable polyester film obtained using a motion capture device, as shown in FIGS. 1A to 1C as an example, the method including the following steps (a) to (e).

Step (a): A step of setting two measurement positions in a main shrinkage direction of a heat-shrinkable polyester film as an object to be measured, and measuring an interval between the two measurement positions as L1.

Step (b): A step of providing a predetermined marker at each of the two measurement positions.

Step (c): A step of heating the heat-shrinkable polyester film at a temperature for a time as predetermined heat shrinkage conditions to cause the film to undergo heat shrinkage.

Step (d): A step of measuring the interval between the two measurement positions after heat shrinkage as L′1 by using a motion capture device.

Step (e): A step of calculating a heat shrinkage ratio in the main shrinkage direction of the heat-shrinkable polyester film based on the following Formula (1).

$$Heat shrinkage ratio in TD direction ( \% ) = ( L 1 - {L}^{′} 1 ) / L 1 \times 100 \qquad ( 1 )$$

Hereinafter, various parameters and the like of the heat-shrinkable polyester film of the first embodiment will be specifically described for each configuration, with reference to the drawings as appropriate.

### 1. Heat-Shrinkable Polyester Film

### (1) Polyester Resin

Basically, there is no limitation on the type of the polyester resin; however, it is preferable that the polyester resin is usually a polyester resin formed from a diol and a dicarboxylic acid, a polyester resin formed from a diol and a hydroxycarboxylic acid, a polyester resin formed from a diol, a dicarboxylic acid, and a hydroxycarboxylic acid, or a mixture of these polyester resins.

### (2) Configuration

It is preferable that various additives are blended into the heat-shrinkable polyester film of the first embodiment, or those additives are attached onto one surface or both surfaces of the film.

More specifically, it is preferable that at least one of a hydrolysis preventing agent, an antistatic agent, an ultraviolet absorber, an infrared absorber, a colorant, an organic filler, an inorganic filler, an organic fiber, an inorganic fiber, and the like is blended usually in an amount within the range of 0.01% to 10% by weight, and more preferably within the range of 0.1% to 1% by weight, with respect to the total amount of the heat-shrinkable polyester film.

Furthermore, as shown in FIG. 1B, it is also preferable that other resin layers 10a and 10b each containing at least one of these various additives are laminated on one surface or both surfaces of the heat-shrinkable polyester film 10.

In that case, it is preferable that when the thickness of the heat-shrinkable polyester film is taken as 100%, the single layer thickness or the total thickness of the other resin layers that are additionally laminated usually has a value within the range of 0.1% to 10%.

Then, the resin as a main component constituting the other resin layers may be the same polyester resin as that of the heat-shrinkable polyester film, or the resin is preferably at least one of an acrylic resin different from the polyester resin, an olefin resin, a urethane resin, a rubber resin, and the like.

Furthermore, it is also preferable that the heat-shrinkable polyester film is made to have a multilayer structure to further promote a hydrolysis preventive effect and mechanical protection, or as shown in FIG. 1C, a shrinkage ratio adjusting layer 10c is provided on the surface of the heat-shrinkable polyester film 10 so that the shrinkage ratio of the heat-shrinkable polyester film becomes uniform within the plane.

Such a shrinkage ratio adjusting layer can be laminated using an adhesive, a coating method, a heating treatment, or the like, depending on the shrinkage characteristics of the heat-shrinkable polyester film.

More specifically, the thickness of the shrinkage ratio adjusting layer is within the range of 0.1 to 3 μm, and in a case where the shrinkage ratio of the heat-shrinkable polyester film at a predetermined temperature is excessively large, it is preferable to laminate a shrinkage ratio adjusting layer of a type that decreases the shrinkage ratio.

Furthermore, in a case where the shrinkage ratio of the heat-shrinkable polyester film at a predetermined temperature is excessively small, it is preferable to laminate a shrinkage ratio adjusting layer of a type that increases the shrinkage ratio.

Therefore, it is intended to obtain a desired shrinkage ratio by using a shrinkage ratio adjusting layer, without producing various heat-shrinkable films having different shrinkage ratios as the heat-shrinkable polyester film.

### 2. Step (a)

Step (a) is a step of preparing a heat-shrinkable polyester film as an object to be measured, setting two measurement positions in the main shrinkage direction of the film, and measuring the interval between the two measurement positions as L1.

That is, first, it is preferable that main agents and additives such as a crystalline polyester resin, a non-crystalline polyester resin, a rubber resin, an antistatic agent, and a hydrolysis preventing agent are prepared as raw materials.

Next, it is preferable that the prepared crystalline polyester resin, non-crystalline polyester resin, and the like are introduced into a stirring container while being weighed, and the materials are mixed and stirred using a stirring device until the mixture becomes uniform.

Next, it is preferable that the uniformly mixed raw materials are dried into an absolute dry state.

Next, typically, it is preferable that extrusion molding is carried out to produce a raw sheet having a predetermined thickness.

More specifically, for example, extrusion molding is carried out under the conditions of an extrusion temperature of 260° C. using an extruder with an L/D ratio of 24 and an extrusion screw diameter of 50 mm (manufactured by Tanabe Plastics Machinery Co., Ltd.), and a raw sheet having a predetermined thickness (usually, 10 to 100 μm) can be obtained.

Next, the obtained raw sheet is heated and pressed while being moved on rolls or between rolls using a heat-shrinkable film manufacturing apparatus, to produce a heat-shrinkable polyester film.

That is, it is preferable that polyester molecules constituting the heat-shrinkable polyester film are crystallized into a predetermined shape by stretching the film in a predetermined direction, while heating and pressing the film at a predetermined stretching temperature and a predetermined stretch ratio while basically expanding the film width.

Then, a heat-shrinkable polyester film that is used for decoration, labeling, and the like by solidifying the film in that state, can be produced.

Incidentally, in this stage, it can be said that it is preferable to measure the haze value and glass transition point of the heat-shrinkable polyester film, or various thermal characteristics in advance.

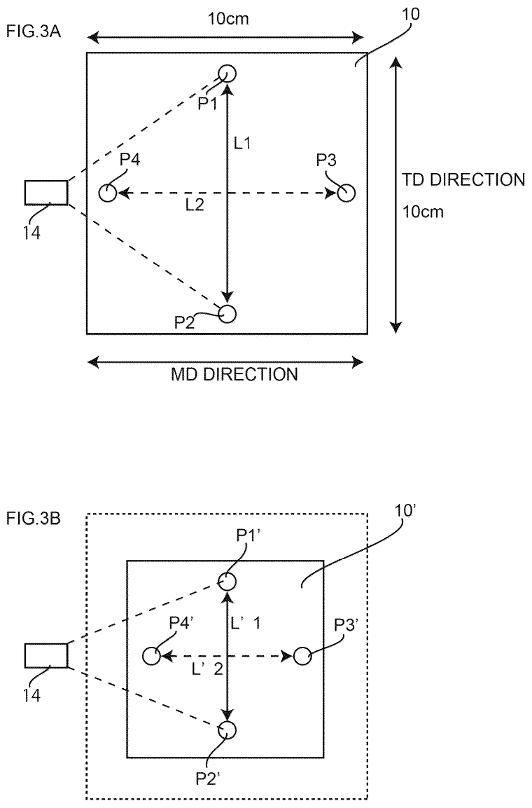

Next, as shown in FIG. 3A, it is preferable that a step of setting two measurement positions (P1 and P2) in the TD direction, which is the main shrinkage direction of the heat-shrinkable polyester film 10 before the film is caused to undergo heat shrinkage.

Then, the interval as a linear distance between the two measurement positions in the TD direction (P1 and P2) before the film is caused to undergo heat shrinkage, is designated as L1.

Furthermore, it is preferable that the value of the interval L1 (mm) between two measurement positions is appropriately selected according to the size of the heat-shrinkable polyester film, the type of the motion capture device, and the like; however, it is preferable that the interval L1 has, for example, a value within the range of 3 to 300 mm.

The reason for this is that, with such an interval, the difference in the interval before shrinkage and after shrinkage of the film can be clearly recognized, and the heat shrinkage ratio in the TD direction can be measured more quickly and accurately.

Therefore, it is more preferable that the interval L1 (mm) of the measurement positions has a value within the range of 5 to 100 mm, and more preferably a value within the range of 8 to 30 mm.

Furthermore, with regard to the two measurement positions (P1 and P2), it is preferable that, when the planar shape of the heat-shrinkable polyester film is a strip (rectangular) shape or a square shape, the measurement positions are usually provided at locations 5 mm or more away from the end parts of the film so that both end parts thereof remain free.

In that case, it is preferable to check that the thickness of the heat-shrinkable polyester film has a value within a predetermined range.

Furthermore, the measurement position is a portion indicating the positional information of coordinates provided on the heat-shrinkable polyester film in order to measure the behavior of the heat-shrinkable polyester film during heat shrinkage.

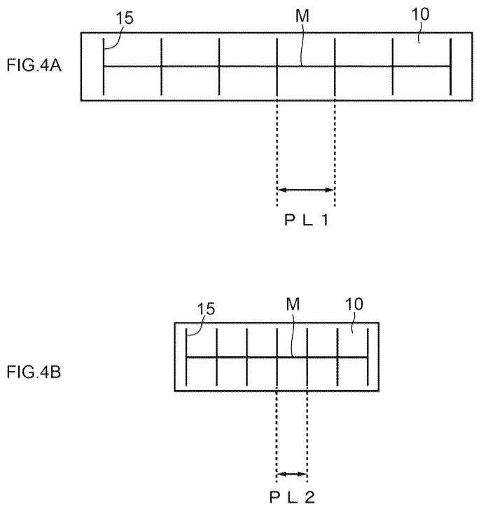

That is, as shown in FIGS. 4A and 4B, it is preferable that a predetermined marker 15 such as a dot, a line, a cross, a circle, an arrow, letter L, letter T, or a check mark is recorded as a predetermined section M between two measurement positions.

The reason for this is that, by adopting such a configuration, the state of the heat-shrinkable polyester film undergoing shrinkage can be easily recognized from the surroundings.

Furthermore, as shown in FIG. 3A, it is preferable that a step of setting two measurement positions (P3 and P4) other than the above-mentioned two measurement positions (P1 and P2) in the MD direction, which is a direction orthogonally intersecting the main shrinkage direction, is carried out.

Then, it is preferable that the interval as a linear distance between the two measurement positions in the MD direction (P3 and P4) before the film is caused to undergo heat shrinkage, is designated as L2.

Here, with regard to the two measurement positions in the MD direction (P3 and P4), when the planar shape of the heat-shrinkable polyester film is a strip (rectangular) shape or a square shape, the measurement positions are usually provided at locations 5 mm or more away from the end parts of the film, in the same manner as for the measurement positions in the TD direction.

### 3. Step (b)

Step (b) is a step of providing a predetermined marker at each of the two measurement positions (P1 and P2) of the heat-shrinkable polyester film, as shown in FIGS. 4A and 4B.

That is, in the case of using an image-type motion capture device, it is preferable that, for example, an oil marker, a metal wire, or a groove is inserted as a predetermined marker, and images of the position of such a predetermined marker are captured with an optical camera.

Next, it is preferable that the pixel count is read from the data of captured video image to acquire the interval between the two measurement positions based on the relation to the actual measurement.

Therefore, by selecting and using an image-type motion capture device from among motion capture devices of various types, the positions of the predetermined markers can be efficiently calculated, and the heat shrinkage ratio can be measured quickly and accurately.

On the other hand, in the case of using an inertial-type motion capture device, it is preferable to attach an inertial marker as the predetermined marker.

That is, an IMU (principal part of a motion capture device) including an accelerometer or an angular velocity meter can acquire information on acceleration or the like from the inertial markers more efficiently and more accurately, and further, the heat shrinkage ratio in the TD direction can be measured more quickly and accurately.

Incidentally, when a plurality of measurement samples are cut out from three locations (W, C, and E) along the TD direction, it is preferable that an inertial marker is attached to each of two measurement positions in each measurement sample.

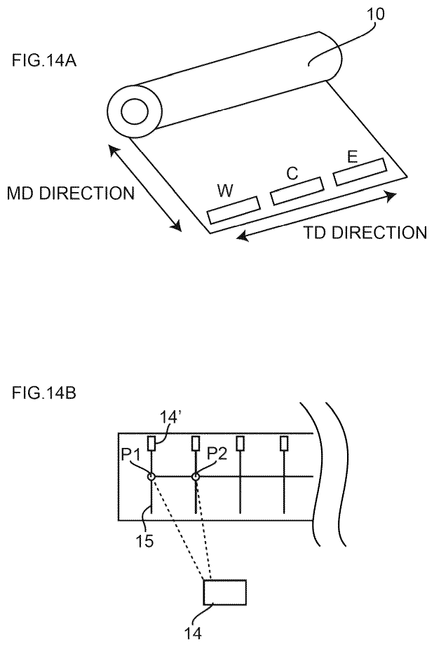

Then, as shown in FIGS. 14A and 14B, when a measurement sample is cut out from each of the three locations (W, C, and E) along the TD direction, and a plurality of samples are obtained, it is preferable that predetermined markers are provided at two measurement positions of each of the measurement samples (W, C, and E), and measurements are made.

Here, it is preferable that the inertial sensor 14′ shown in FIGS. 14A and 14B is a combination of a long-axis sensor and several short-axis sensors intersecting the long-axis sensor at 90° at equal intervals, and at least two measurement points are provided at any position with a predetermined interval.

However, the inertial sensor 14′ is not limited to the form of a combination of these, and it is also preferable that the planar shape is at least one of a circle, a triangle, a quadrangle, a polygon, and an irregular shape.

In addition, it is preferable that at least the two measurement points are made of a metal marker, or a printed material such as a paint containing a metallic material, so that sensing can be performed more quickly and accurately.

### 4. Step (c)

Step (c) is a step of heating the heat-shrinkable polyester film as an object to be measured using a heat shrinking device at a predetermined temperature for a predetermined time as heat shrinkage conditions to cause the film to undergo heat shrinkage.

Here, it is preferable that the heat shrinking device is at least one of a constant temperature bath (oven), a steam bath, a hot water bath, a hot air heater, a liquid bath of a fluorine-containing compound, a steam bath of a fluorine-containing compound, and an infrared ray irradiating apparatus.

The reason for this is that when a motion capture device is used, these various heat shrinking devices can be used according to the use applications and the like of the heat-shrinkable polyester film, and further, the heat shrinkage ratio can be measured more simply and more accurately.

Furthermore, as an example, it is preferable that the heat shrinking device is a hot water bath.

The reason for this is that, by using such a heat shrinking device, it is easy to maintain the temperature of the hot water constant, and the control of the heat shrinkage temperature can be carried out more precisely.

In addition, it is because, by using a hot water bath, the heat-shrinkable polyester film can be floated and heated planarly and uniformly, and the behavior of the heat-shrinkable polyester film during heat shrinkage can be captured more easily from above with an optical camera or the like.

In addition, as another example, it is preferable that the heat shrinking device is a hot air heater.

That is, it is preferable to use, as the hot air heater, a device in which air supplied by a compressed air pump, a fan, or the like is blown onto an object via a heat source such as an electric heating wire or an oil heater.

Specifically, for example, the heat shrinking device is preferably configured such that a heat-shrinkable polyester film planarly placed on a belt conveyor or a mounting table, is caused to undergo heat shrinkage by blowing hot air from vertically above the heat-shrinkable polyester film.

The reason for this is that, by using such a heat shrinking device, the degree of freedom for the place of disposition of the device is increased, the heat shrinking device can be disposed above a heat-shrinkable polyester film manufacturing apparatus, and the heat shrinkage rate can be measured more easily in-line by blowing hot air onto cut-off ends and the like.

Therefore, in the case of using a hot air heater in this way, from the viewpoint of effectively transferring the quantity of heat of the hot air to the heat-shrinkable polyester film, the heat-shrinkable polyester film is preferably configured to receive the hot air within a tunnel-shaped housing made of stainless steel, aluminum, glass, or the like.

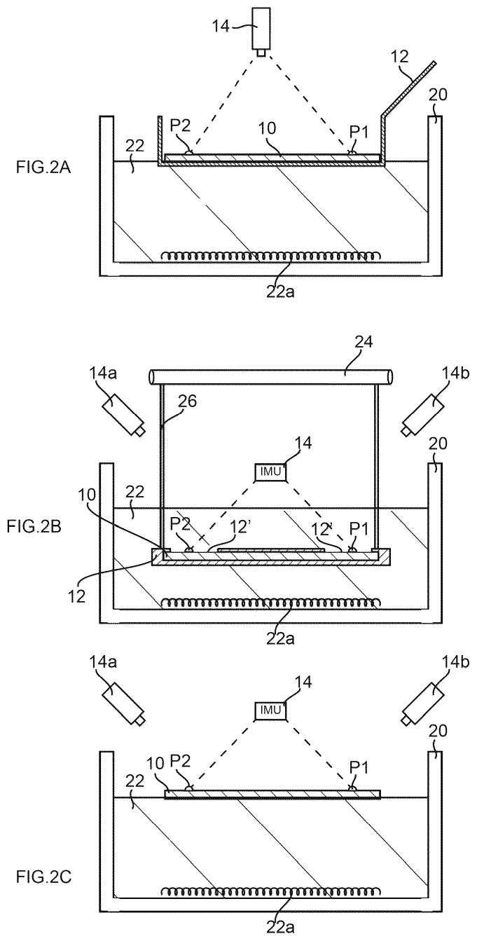

Specifically, as shown in FIGS. 2A to 2C, for example, it is preferable that a hot water bath 20 that holds hot water 22 maintained at a predetermined temperature by a heater 22a is prepared, and the heat-shrinkable polyester film is caused to undergo heat shrinkage in the TD direction by immersing the film in hot water under the conditions of a heat shrinkage temperature of 70° C. to 98° C. for a shrinkage time of 1 to 60 seconds.

At that time, as shown in FIG. 2B, it is preferable that a mesh-shaped fixing jig 12 formed from, for example, stainless steel wires or the like is prepared so that the heat-shrinkable polyester film is uniformly immersed and heated, and the heat-shrinkable polyester film 10 is partially accommodated inside the fixing jig.

In addition, it is preferable that the fixing jig 12 is provided with an opening part 12′ having a predetermined size at the locations corresponding to the measurement points P1 and P2 so that the heat-shrinkable polyester film 10 is prevented from stretching or the like in the thickness direction, and the shrinkage ratio can be measured using a motion capture device or the like.

Furthermore, it is preferable that at least two linear objects 26 are attached to both end parts of the heat-shrinkable polyester film 10 through the fixing jig 12, so that the heat-shrinkable polyester film is further uniformly immersed and heated for a predetermined time.

That is, it is preferable that wires and the like as these linear objects 26 are further connected to a lifter 24, and the lifter 24 is configured to be capable of moving up and down at a constant speed while maintaining the horizontal direction of the heat-shrinkable polyester film 10 by winding up or unwinding the linear objects 26.

Furthermore, as a step of causing the heat-shrinkable polyester film to undergo heat shrinkage, from the viewpoint of preventing the occurrence of temperature unevenness, as shown in FIG. 2B as an example, it is preferable that the heat-shrinkable polyester film 10 is immersed in hot water in the hot water bath 20 and caused to undergo heat shrinkage.

On the other hand, from the viewpoint of making a measurement more quickly and more simply, as shown in FIGS. 2A and 2C, it is also preferable that the heat-shrinkable polyester film 10 is floated on the surface of the hot water 22 maintained at a predetermined temperature in the hot water bath 20, and is caused to undergo heat shrinkage.

Furthermore, upon causing the heat-shrinkable polyester film to undergo heat shrinkage, it is preferable to use a frame-shaped fixing jig that maintains the position of the heat-shrinkable polyester film without interfering with the shrinkage of the heat-shrinkable polyester film.

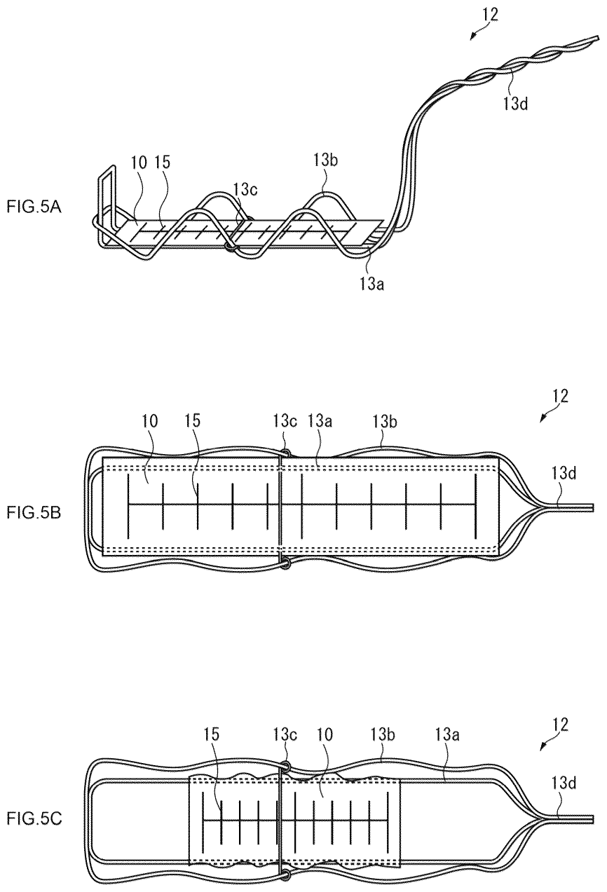

That is, as shown in FIGS. 5A to 5C as an example, it is preferable that the fixing jig 12 has a placement part 13a that is composed of a frame member and places and maintains at least the heat-shrinkable polyester film; a guide part 13b that controls the shrinkage direction of the heat-shrinkable polyester film; and a regulating part 13c that prevents misalignment during heat shrinkage.

In addition, from the viewpoint of further improving handleability, it is preferable that the fixing jig 12 is provided with at least a handle part 13d that is disposed at an end part in the main shrinkage direction of the placement part 13a and protrudes obliquely upward.

Specifically, it is preferable that the fixing jig is composed of a metal wire made of stainless steel, iron, aluminum, copper, or the like, or a frame member made of a resin or the like.

The reason for this is that, by configuring the fixing jig in this way, the heat-shrinkable polyester film can be stably placed, and at the same time, the heat shrinkage rate can be measured more accurately by reducing shake during heat shrinkage.

Furthermore, from the viewpoint of the ease of handling and uniform heating of the heat-shrinkable polyester film, it is preferable that the placement part is a substantially flat frame-shaped part and is two rail-shaped parts parallel to at least the main shrinkage direction when viewed in a plan view from vertically above.

Furthermore, it is preferable that the guide part is a part that is disposed parallel to the placement part when viewed in a plan view from vertically above, and curves in a wavy form up and down in the vertical direction.

In addition, the regulating part is a part disposed to bridge the guide part in a direction perpendicular to the main shrinkage direction and made movable up and down along the frame of the guide part, and is a part that clamps the heat-shrinkable polyester film placed on the placement part, between the placement part and the regulating part.

The reason for this is that, by configuring the guide part in this way, a positional shift of the heat-shrinkable polyester film can be prevented during heat shrinkage, and at the same time, the center position of shrinkage can be stabilized so as to accurately measure the heat shrinkage rate using a motion capture device.

Then, by curving the guide part into a wavy form, for example, when a hot water bath is used as the heat shrinking device during heat shrinkage, the heat-shrinkable polyester film can be landed on water without creating waves, and by adjusting the height of the guide part to match the water level, measurements can be made with the guide part placed at the bottom of the water bath.

### 5. Step (d)

Step (d) is a step of measuring the interval between two measurement positions in the TD direction (P1′ and P2′) of the heat-shrinkable polyester film 10′ after heat shrinkage as a second distance, as shown in FIG. 3B.

That is, as shown in FIG. 3B and FIGS. 14A and 14B, it is preferable that a predetermined motion capture device 14 is prepared, and the interval between two measurement positions in the TD direction of the heat-shrinkable polyester film that is caused to undergo heat shrinkage under predetermined conditions, is measured as L′1 (sometimes referred to as a second distance) using the motion capture device 14.

On the other hand, it is also preferable that the interval between two measurement positions of such a heat-shrinkable polyester film before heat shrinkage or during heat shrinkage is measured continuously (for example, at time intervals of 0.01 to 1 second) by using a motion capture device or the like.

Furthermore, as shown in FIG. 3B, it is preferable that a step of measuring the interval between two measurement positions in the MD direction (P3′ and P4′) as a second-prime (2^{nd}′) distance using a motion capture device, is carried out.

Then, the interval as a linear distance between the two measurement positions in the MD direction (P3′ and P4′) after heat shrinkage is designated as L′2.

That is, it is preferable to measure the 2^{nd}′ distance in the MD direction in the same manner as in the measurement of the 2nd distance in the TD direction.

It is preferable that the interval between the measurement positions in the heat-shrinkable polyester film is calculated based on the positional information of the measurement positions obtained by a motion capture device.

The reason for this is that, by using such a motion capture device, the interval between the measurement positions on the film can be acquired quickly and accurately as digital data.

Here, motion capture is a technology for converting the movement of a measurement target into digital data, and is mainly a technology for tracking the position of a predetermined marker that serves as a measurement target and recording the position as coordinate data.

Specifically, the type of the motion capture device is not particularly limited; however, there are image-type motion capture devices, inertial motion capture devices, optical motion capture devices, and motion capture devices as combinations of these, among which any type of motion capture device can be used.

However, in the case of the heat-shrinkable polyester film, since the film is subjected to heating through hot water immersion or the like, under a condition that there are many spatial limitations, in view of being easily adopted as a miniaturized or simplified device, it can be said to be more preferable to use an image-type or inertial motion capture device.

Here, when a single motion capture device is used, the heat shrinkage ratio can be measured from two-dimensional measurement points and calculated, whereas when a plurality of motion capture devices are used, there is an advantage that the positional relation of three-dimensional measurement points can be measured, and the heat shrinkage ratio can be measured and calculated.

For example, even when a flat plate-shaped hot plate is used as a heat shrinking device, and when the device is disposed not only in a horizontal direction but also in a vertical direction so as to be tilted along the direction of gravity or to be parallel to the direction of gravity, the heat shrinkage ratio can be easily and quickly measured three-dimensionally.

Therefore, when a single motion capture device or a plurality of motion capture devices are used, since various heat shrinkage devices can be used, measurement of the heat shrinkage ratio can be carried out more quickly, more accurately, and more simply depending on the use applications and the like of the heat-shrinkable polyester film.

More specifically, as shown in FIG. 2A, it is preferable that the heat shrinkage ratio is measured using an optical camera as an image-type motion capture device 14, capturing a video image during heat shrinkage of the heat-shrinkable polyester film 10 as an object to be measured, and performing image analysis on the acquired data.

That is, it is preferably configured that a plurality of graduations (for example, 2 to 30 marks) are provided in advance at intervals of L1 on the heat-shrinkable polyester film using a predetermined marker such as an oil marker.

Next, it is preferably configured that the heat-shrinkable polyester film is placed on a flat surface, and video images before and after heat shrinkage are captured from vertically above using an optical camera.

In addition, it is preferably configured that the intervals between graduation marks before heat shrinkage are each calculated from the data of the captured video images from the relation between the pixel count and the actual measurement data, and the average value of the intervals is defined as the heat shrinkage ratio.

Specifically, for example, in an embodiment in which graduation marks are lined up on the left and right sides, it is preferable that a horizontal imaginary line is drawn so as to intersect with each graduation mark, and the point at which a graduation mark and the imaginary line intersect with each other is defined as the measurement position.

The reason for this is that, by continuously recording the state of heat shrinkage as video image data, the heat shrinkage ratio in the TD direction can be measured more quickly, more accurately, and more efficiently.

It is because, by recording in this way, even in a case where there are many spatial limitations, the device can be further miniaturized and simplified, and the heat shrinkage ratio can be measured more efficiently.

Incidentally, the type of the predetermined marker would be any form that is easily recognized by an optical camera; however, it is preferably configured that the predetermined marker is, for example, an oil marker or a groove.

Furthermore, it is preferable that the motion capture device is configured as an inertial position measuring device that can obtain information on acceleration, angular velocity, and orientation obtained from inertial sensors attached to the heat-shrinkable polyester film using a device such as IMU, and accurately specify the position of a marker (center of gravity or the like).

That is, it is preferable that the motion capture device is an inertial motion capture device equipped with 9-axis inertial sensors that combine an accelerometer and an angular velocity meter (gyro sensor) and further combine these with a geomagnetometer.

On the other hand, it is also preferable to use an optical motion capture device as the motion capture device.

That is, it is preferable that the motion capture device is a kind of optical position measuring device of a type that irradiates radiation such as infrared rays from the motion capture device toward an optical marker (a retroreflective marker or the like) and detects the reflected light.

Such a motion capture device is a measuring device that can perform predetermined image processing based on the obtained reflected light and two-dimensionally identify the position (center of gravity or the like) of a marker, and is capable of three-dimensional position identification by using a plurality of motion capture devices in combination.

Furthermore, as shown in FIGS. 2B and 2C, it is preferable that images of the state of heat shrinkage of the heat-shrinkable polyester film 10 are captured as well by using predetermined optical cameras 14a and 14b in combination with an inertial motion capture device 14, and the images are used as image data to serve as a reference for measuring the heat shrinkage ratio.

The reason for this is that, by combining camera images and continuously recording the state of heat shrinkage in this way, the state of heat shrinkage in the TD direction can be checked as image data, and further, the heat shrinkage ratio in the TD direction can be measured more efficiently and more accurately.

More specifically, it is preferable that a single optical camera or a plurality of optical cameras are prepared, and image data of the state of heat shrinkage of the heat-shrinkable polyester film are captured from the front, side, top, back, or oblique directions of the heat-shrinkable polyester film as an object to be measured.

### 6. Step (e)

Step (e) is a step of calculating the heat shrinkage ratio in the main shrinkage direction of the heat-shrinkable polyester film as the heat shrinkage ratio in the TD direction, based on Formula (1).

That is to say, it is preferable that the heat shrinkage ratio in the TD direction is calculated from the obtained L1 and L2, based on Formula (1).

Furthermore, when calculating the heat shrinkage ratio in the TD direction, it is preferable that the interval between two measurement positions is set at a plurality of sites, the heat shrinkage in the TD direction at the plurality of sites is calculated, and the average value thereof is designated as the heat shrinkage ratio in the TD direction.

That is, it is preferable to select a plurality of different locations (for example, n=3 to 30 locations) on the same film, and take the average value of the measured heat shrinkage ratios (temperature: 70° C. to 98° C., time: 1 to 60 seconds) as the heat shrinkage ratio in the TD direction.

The reason for this is that, by calculating the heat shrinkage in the TD direction at a plurality of sites, the heat shrinkage ratio in the TD direction can be measured more quickly and accurately.

Therefore, it is more preferable to select at least 4 to 20 locations of measurement positions, and even more preferably 5 to 10 locations of measurement positions, in the TD direction of the heat-shrinkable polyester film.

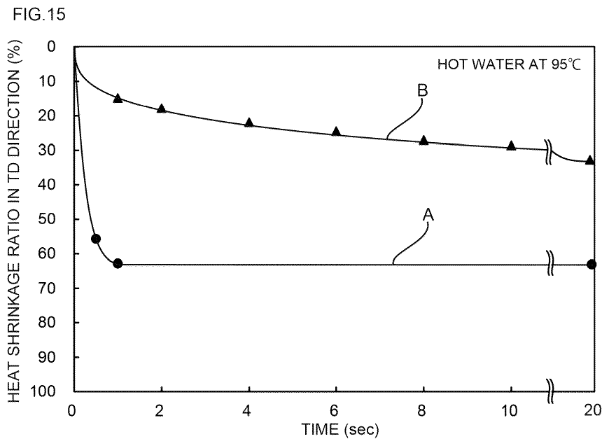

Here, referring to FIG. 15, the relation between the immersion time in a case where the film is immersed in hot water at 95° C., and the heat shrinkage ratio (%) in the TD direction measured using a motion capture device in Example 2 and Comparative Example 1 will be described.

That is, the axis of abscissa in FIG. 15 represents the immersion time (seconds), and the axis of ordinate represents the heat shrinkage ratio (%) in the TD direction measured using a motion capture device.

In the case of the characteristic curve of Example 2 (line A), when the immersion time is about 1 second, a heat shrinkage ratio (%) that is almost equal even when compared with the value obtained after a lapse of 20 seconds, is obtained.

In contrast, in the case of the characteristic curve of Comparative Example 1 (line B), when the heat shrinkage ratio (%) in the case of an immersion time of 1 second is compared with the heat shrinkage ratio in the case of an immersion time of 20 seconds, a tendency that the heat shrinkage ratio (%) increases as the immersion time is longer is obtained.

Therefore, it can be said that it is preferable to determine the immersion time by taking into consideration the PET resin used, the thickness and thermal characteristics of the resulting heat-shrinkable polyester film, as well as manufacturing conditions.

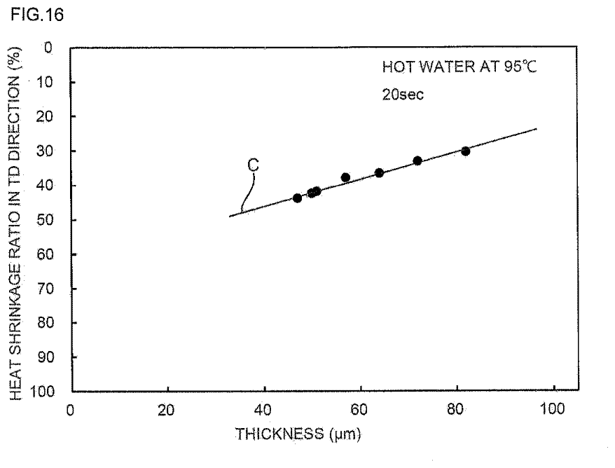

In addition, referring to FIG. 16, the relation between the thickness (μm) of the heat-shrinkable polyester film when the film is immersed in hot water at 95° C. for 20 seconds, and the heat shrinkage ratio (%) in the TD direction measured using a motion capture device, will be described.

That is, the axis of abscissa in FIG. 16 represents the thickness (μm) of the heat-shrinkable polyester film, and the axis of ordinate represents the heat shrinkage ratio (%) in the TD direction measured using a motion capture device.

Therefore, in the case of such a characteristic curve (line C), it is understood that a lower heat shrinkage ratio (%) is obtained as the thickness (μm) of the heat-shrinkable polyester film is larger, and there is a predetermined correlation (linear relationship).

Therefore, it can be said that it is preferable to adjust the heat shrinkage ratio (%) by taking the thickness and thermal characteristics of the heat-shrinkable polyester film into consideration.

### 7. Step (f)

It is preferable that step (f) is provided to check whether the obtained predetermined heat shrinkage ratio (temperature: 70° C. to 98° C., time: 1 to 60 seconds) is equal to or more than a predetermined value (for example, 20% or more), while comparing with a calibration curve.

That is, it is preferable to check that the values of the thickness of the heat-shrinkable polyester film checked in step (1) and the heat shrinkage ratio each match to a previously prepared calibration curve showing the relation between the thickness of the heat-shrinkable polyester film and the heat shrinkage ratio measured using a motion capture device.

Conversely, when the heat shrinkage ratio is below 20%, it is preferable to adjust the predetermined heat shrinkage ratio to be within a predetermined range by reducing the thickness of the heat-shrinkable polyester film, or changing the raw materials of the heat-shrinkable polyester film or the manufacturing conditions.

Therefore, it is preferable to check that the predetermined heat shrinkage ratio (temperature: 70° C. to 98° C., time: 1 to 60 seconds) has a value of 30% to below 95%, more preferably a value within the range of 40% to below 90%, and even more preferably a value of 50% to below 85%.

More specifically, it is preferable that a heat shrinkage ratio A1 in a case where the main shrinkage direction is defined as TD direction, and the film is caused to shrink in the TD direction under the conditions of a temperature of 95° C. for 1 second, is adjusted to have a value within the range of 30% to below 95%.

The reason for this is that, by limiting such 95° C. heat shrinkage ratio A1 to be 30% to below 95%, satisfactory wrinkling characteristics are obtained for the heat-shrinkable polyester film during heat shrinkage, and further, the maximum shrinkage stress is also easily obtained.

Therefore, it is more preferable to adjust the 95° C. heat shrinkage ratio A1 to have a value within the range of 40% to below 90%, and it is even more preferable to adjust the 95° C. heat shrinkage ratio A1 to have a value within the range of 50% to below 85%.

Furthermore, it is preferable that a heat shrinkage ratio A′1 in a case where the main shrinkage direction is defined as TD direction, and the film is caused to shrink in the TD direction under the conditions of a temperature of 95° C. for 10 seconds, is adjusted to have a value within the range of 60% to below 95%.

The reason for this is that, by limiting such 95° C. heat shrinkage ratio A′1 to be 60% to below 95%, satisfactory wrinkle characteristics are obtained for the heat-shrinkable polyester film during heat shrinkage, and further, the maximum shrinkage stress is also easily obtained.

Therefore, it is more preferable to adjust the 95° C. heat shrinkage ratio A′1 to have a value within the range of 65% to below 90%, and it is even more preferable to adjust the 95° C. heat shrinkage ratio A′1 to have a value within the range of 70% to below 85%.

Furthermore, with regard to the heat-shrinkable polyester film as an object to be measured, as configuration (a2), it is preferable that a heat shrinkage ratio A2 in a case where the main shrinkage direction is defined as TD direction, and the film is caused to shrink in the TD direction under the conditions of a temperature of 80° C. for 1 second, has a value within the range of 10% to below 80%.

The reason for this is that, by adjusting such 80° C. heat shrinkage ratio A2 to be within a predetermined range, a more satisfactory heat shrinkage ratio is obtained for the heat-shrinkable polyester film during heat shrinkage, and further, the maximum shrinkage stress is also easily obtained.

Therefore, as the configuration (a2), it is more preferable that the 80° C. heat shrinkage ratio A2 has a value within the range of 15% to below 70%, and even more preferably a value within the range of 20% to below 50%.

Furthermore, with regard to the heat-shrinkable polyester film as an object to be measured, as configuration (a′2), it is preferable that a heat shrinkage ratio A′2 in a case where the main shrinkage direction is defined as TD direction, and the film is caused to shrink in the TD direction under the conditions of a temperature of 80° C. for 10 seconds, has a value within the range of 10% to below 85%.

The reason for this is that, by adjusting such 80° C. heat shrinkage ratio A′2 to be within a predetermined range, a more satisfactory heat shrinkage ratio is obtained, and further, the maximum shrinkage stress is also easily obtained.

Therefore, as the configuration (a′2), it is more preferable that the 80° C. heat shrinkage ratio A′2 has a value within the range of 20% to below 75%, and even more preferably a value within the range of 30% to 65%.

Furthermore, it is preferable that a step of calculating a heat shrinkage ratio in the MD direction from L2, which is the distance between two points before heat shrinkage, and L′2, which is the distance between two points after heat shrinkage, in the same manner as for the heat shrinkage ratio in the TD direction, and adjusting such a heat shrinkage ratio in the MD direction, is carried out.

Then, it is preferable to adjust the heat shrinkage ratio in the MD direction of the heat-shrinkable polyester film to have a value within the range of −5% to 5%.

The reason for this is that, by simultaneously adjusting the heat shrinkage ratio in the MD direction in this way, the heat shrinkage characteristics at the time of actually using the heat-shrinkable polyester film can be controlled more easily according to the use applications and the like of the heat-shrinkable polyester film.

Furthermore, it is also preferable to have a step of adjusting the standard deviation of the heat shrinkage ratio (temperature: 70° C. to 98° C., time: 1 to 60 seconds), as a predetermined adjustment step.

More specifically, it is preferable that when the heat shrinkage ratio in the TD direction is calculated, the standard deviation (σ1) of the heat shrinkage ratio in the TD direction at a predetermined temperature for a predetermined time is adjusted to be 15% or less.

That is, when the standard deviation of the heat shrinkage ratio in the TD direction is above 15%, it is preferable that the standard deviation of the heat shrinkage ratio is adjusted to be within a predetermined range by reducing the thickness of the heat-shrinkable polyester film, or changing the raw materials of the heat-shrinkable polyester film or the manufacturing conditions.

The reason for this is that, by adjusting the standard deviation of the heat shrinkage ratio in this way, the heat shrinkage ratio of the heat-shrinkable polyester film can be controlled more precisely.

Therefore, it is more preferable to adjust the standard deviation of the heat shrinkage ratio in the TD direction to have a value of 10% or less, and it is even more preferable to adjust the standard deviation to have a value of 5% or less.

Furthermore, it has been found that the heat shrinkage ratio measured using a motion capture device could be affected by the thickness of the heat-shrinkable polyester film.

That is, it is preferable that the thickness of the heat-shrinkable polyester film is adjusted to be within the range of 10 to 200 μm, and the difference between the maximum value of the thickness and the average value of the thickness (hereinafter, sometimes referred to as a variation in thickness) is adjusted to have a value of 10 μm or less.

The reason for this is that, by controlling the thickness and the variation in thickness of such a heat-shrinkable polyester film, the heat shrinkage ratio in the TD direction is also easily controlled, and further, the heat shrinkage ratio in the TD direction can be controlled more quickly and precisely.

However, when such a variation in thickness is excessively small, the production yield is extremely lowered, and it would be economically disadvantageous.

Therefore, it is more preferable to adjust the variation in thickness to have a value within the range of 0.01 to 5 μm, and it is even more preferable to adjust the variation in thickness to have a value within the range of 0.1 to 3 μm.

Furthermore, upon measuring the heat shrinkage ratio using a motion capture device, the haze value of the heat-shrinkable polyester film could affect the accuracy of image reading.

That is, upon measuring the heat shrinkage ratio, it is preferable to adjust the haze value of the heat-shrinkable polyester film measured according to JIS K 7136:2000 to have a value of 7% or less.

On the other hand, it is because when the haze value of the film before heat shrinkage becomes excessively small, it would be difficult to control the haze value in a stable manner, and the production yield would decrease significantly.

Therefore, it is more preferable to adjust the haze value of the film obtained before heat shrinkage to a value within the range of 0.1% to 5%, and even more preferably to a value within the range of 0.5% to 3%.

### 8. Step of Adjusting Other Thermal Characteristics

### (1) Heat Shrinkage Rate

Furthermore, it is preferable to include a step of adjusting the following thermal characteristics such as heat shrinkage rate, as a step of adjusting other thermal characteristics.

Specifically, when the heat-shrinkable polyester film is caused to undergo heat shrinkage along the main shrinkage direction at a predetermined temperature T for a predetermined time t1, it is preferable that a predetermined correlation between the distance information of a predetermined section obtained by a motion capture device and the measurement time is utilized, and the maximum value of the heat shrinkage rate calculated base on Formula (2) is adjusted to a predetermined range.

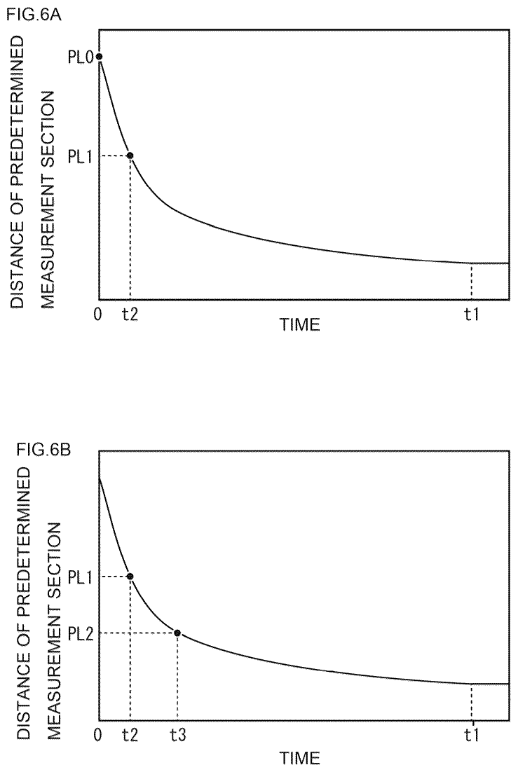

That is, as shown in FIG. 6A, it is preferable that the distance of a predetermined section measured using a motion capture device before heat shrinkage is PL0, the distance of a predetermined section measured using a motion capture device at a predetermined time t2, which is shorter than the predetermined time t1, is PL1, and the maximum value of the heat shrinkage rate that can be calculated based on Formula (2) is 3 mm/sec or more.

$$Heat shrinkage rate ( mm / sec ) = ( PL 0 - PL 1 ) / t 2 \qquad ( 2 )$$

PL0−PL1: distance change of predetermined section (mm)
t2: measurement period (seconds)

The reason for this is that, by taking the maximum value of such a heat shrinkage rate, the balance between the amount of change at which the heat-shrinkable polyester film changes most significantly and the time can be adjusted precisely, and the occurrence of wrinkles and the like in a case where the heat-shrinkable polyester film is used on an object can be effectively prevented.

Therefore, it is more preferable that the maximum value of the heat shrinkage rate is 3.5 mm/sec or more, and even more preferably 4 mm/sec or more.

Incidentally, it is preferable that the distance PLO of a predetermined section before heat shrinkage is the same distance as L1 or the like.

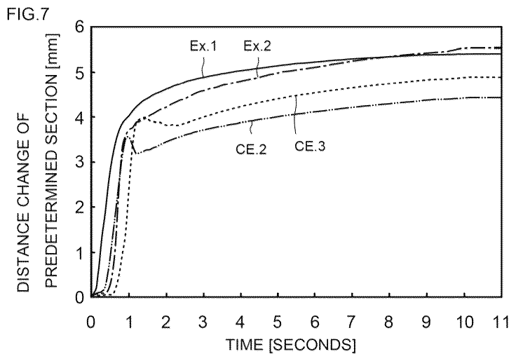

Here, referring to FIG. 7, the relation between time (seconds) and the distance change (mm) of a predetermined section will be described.

That is, for Examples 1 and 2 and Comparative Examples 2 and 3 that will be described below, the time (seconds) was plotted on the axis of abscissa, the maximum value of the distance change (mm) of predetermined sections provided at six locations at a distance of 10 mm along the main shrinkage direction was plotted on the axis of ordinate, and measurements were made at intervals of 0.1 seconds and graphed.

According to such a graph, it can be seen that in Example 1 and Example 2, the value increases uniformly between 0 seconds and 2 seconds, and even thereafter, continues to increase slowly.

It can be seen that in Comparative Example 2, there is a portion between 0 seconds to 1 second, in which the distance change of the predetermined section decreases.

On the other hand, it can be seen that in Comparative Example 3, the distance change of the predetermined section increases gently between 0 seconds to 1 second, rises sharply between 1 second to 2 seconds, and then decreases slightly.

In addition, it can be seen that in Comparative Example 3, at the time point after a lapse of one second from the start of heat shrinkage, the curve is about ⅓ to ½ of other relation curves.

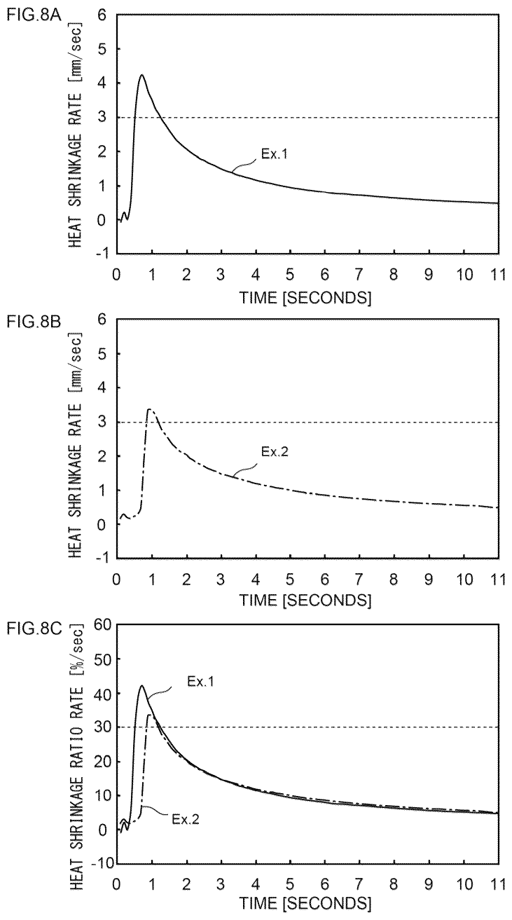

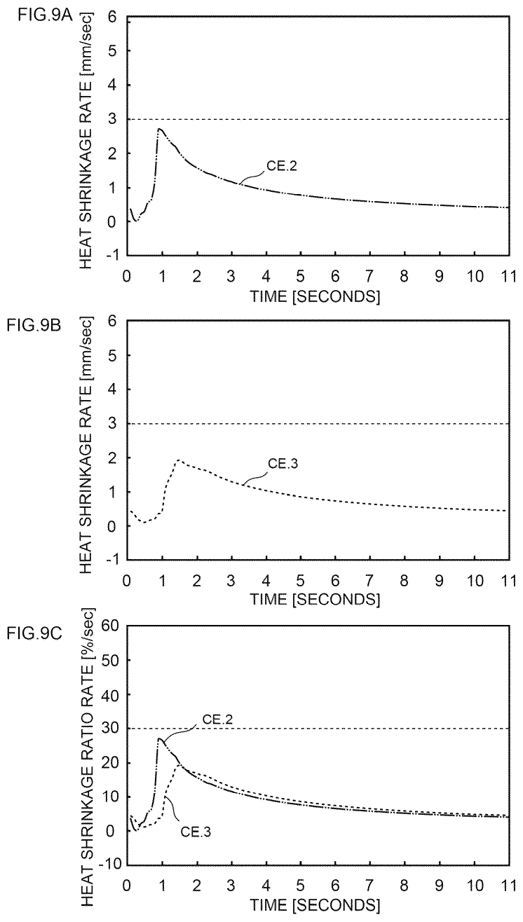

Furthermore, referring to FIGS. 8A and 8B and FIGS. 9A and 9B, the relation between the time (seconds) and the heat shrinkage rate (mm/sec) and heat shrinkage ratio rate (%/sec) will be described.

Specifically, for Examples 1 and 2 and Comparative Examples 1 and 2 that will be described below, the time (seconds) was plotted on the axis of abscissa, the heat shrinkage rate (mm/sec) with the smallest maximum value among predetermined sections provided at six locations at intervals of 10 mm along the main shrinkage direction was plotted on the axis of ordinate, and measurements were made at intervals of 0.1 seconds and graphed.

According to FIGS. 8A and 8B, it can be seen that in Example 1 and Example 2, the heat shrinkage rate increases in a relatively stable manner immediately after the start of heat shrinkage, exceeds 3 mm/sec after a lapse of about 1 second, and decreases to 3 mm/sec or less between 1 second and 2 seconds.

On the other hand, according to FIGS. 9A and 9B, it can be seen that in Comparative Example 2 and Comparative Example 3, the heat shrinkage rate does not increase that much immediately after the start of heat shrinkage, and does not exceed 3 mm/sec even after a lapse of 1 second from the start point of heat shrinkage.

Incidentally, in the case of FIG. 8C and FIG. 9C, a heat shrinkage rate of 1 mm/sec corresponds to a heat shrinkage ratio rate of 10%/sec.

### (2) Heat Shrinkage Ratio Rate

Furthermore, with regard to the heat-shrinkable polyester film, as shown in FIG. 6A, it is preferable that the maximum value of the heat shrinkage ratio rate in the main shrinkage direction calculated based on the following Formula (3) is 30%/sec or more.

$$Heat shrinkage ratio rate ( \% / sec ) = ( PL 0 - PL 1 ) / ( PL 0 \times t 2 ) \times 100 \qquad ( 3 )$$

The reason for this is that, by taking such a heat shrinkage ratio rate, the balance between the amount of change at which the heat-shrinkable polyester film changes most significantly and the time can be adjusted precisely, and the occurrence of wrinkles and the like in a case where the heat-shrinkable polyester film is used on an object can be effectively prevented.

In addition, it is because, by measuring the amount of change related to the heat shrinkage ratio, evaluation of the heat-shrinkable polyester film can be carried out without depending on the distance of the predetermined section.

Therefore, it is more preferable that the maximum value of the heat shrinkage ratio rate is 3.5%/sec or more, and even more preferably 4%/sec or more.

### (3) Standard Deviation of Maximum Value of Heat Shrinkage Rate

Furthermore, with regard to the heat-shrinkable polyester film, it is preferable that when a plurality of predetermined sections are provided, and the heat shrinkage rate for each of the predetermined sections from the start point of heat shrinkage to a predetermined time t1 is determined at every 0.1 seconds, the standard deviation of the maximum value of the heat shrinkage rate for each predetermined section is 3.5 mm/sec or less.

The reason for this is that, by taking such a standard deviation, the shrinkage ratio per hour during heat shrinkage can be adjusted precisely, and the behavior during heat shrinkage is further stabilized.

Therefore, it is more preferable that the standard deviation of the maximum value of the heat shrinkage rate is 1 mm/sec or less, and even more preferably 0.3 mm/sec or less.

Incidentally, the standard deviation is the square root of the sum of the squares of deviations divided by the value of (number of data points−1).

### (4) Heat Shrinkage Rate in Predetermined Period (Intermediate Heat Shrinkage Rate)

Furthermore, with regard to the heat-shrinkable polyester film, as shown in FIG. 6B, when a predetermined section is provided along the main shrinkage direction of the heat-shrinkable polyester film in a state of being capable of shrinking in at least one of the longitudinal direction or the width direction, and the film is caused to undergo heat shrinkage at a predetermined temperature T for a predetermined time t1, it is preferable that the heat shrinkage rate in the main shrinkage direction in a predetermined time period (hereinafter, sometimes referred to as intermediate heat shrinkage rate) is 20 mm/sec or less, as calculated based on the following Formula (4) from the distance change between a distance PL0 of the predetermined section before heat shrinkage, a distance PL1 of the predetermined section at a predetermined time t2, which is shorter than the predetermined time t1, and a distance PL2 of the predetermined section at a predetermined time t3, which is shorter than the predetermined time t1 and longer than the predetermined time t2.

$$Intermediate heat shrinkage ratio ( mm / sec ) = ( PL 1 - PL 2 ) / ( t 3 - t 2 ) \qquad ( 4 )$$

PL1−PL2: distance change of predetermined section (mm)
t3−t2: measurement period (seconds)

The reason for this is that, by adopting such an intermediate heat shrinkage rate, a predetermined correlation between the distance change of a predetermined section of the heat-shrinkable polyester film during heat shrinkage and the positional information obtained by a motion capture device or the like, can be utilized. In addition, it is because the heat shrinkage rate of the heat-shrinkable polyester film can be adjusted to a value within a predetermined range, and excellent heat shrinking property can be stably exhibited.

Therefore, it is more preferable that the heat shrinkage rate in the measurement period is 18 mm/sec or less, and even more preferably 15 mm/sec or less.

Incidentally, the intermediate heat shrinkage rate is defined to have a positive value in the shrinkage direction of the heat-shrinkable polyester film, and is defined to have a negative value in a case where the heat-shrinkable polyester film elongates in reaction to shrinkage, or in a case where the film is three-dimensionally distorted due to rapid heat shrinkage and thereafter returns to a planar shape, or the like.

Furthermore, for the heat-shrinkable polyester film, it is preferable that the measurement period t3−t2 has a value of 3 seconds or less.

The reason for this is that, by adopting such a measurement period, the behavior during heat shrinkage can be measured more accurately.

Therefore, it is more preferable that the measurement period t3−t2 has a value of 2 seconds or less, and even more preferably a value of 1 second or less.

On the other hand, from the viewpoint of preventing an increase in measurement errors and the like caused by excessively increasing the time resolution, it is preferable that the measurement period t3−t2 has a value of 0.1 seconds or more.

Furthermore, it is preferable that the intermediate heat shrinkage rate always has a positive value during heat shrinkage; however, it has been found that even in a case where the intermediate heat shrinkage rate has a negative value, there is no problem with the intended use of the heat-shrinkable polyester film so long as the value is small.

Therefore, with regard to the heat-shrinkable polyester film, it is preferable that the minimum value of the intermediate heat shrinkage rate during that predetermined period is suppressed to be −2.5 mm/sec or more.

It is because, by suppressing the behavior of the heat-shrinkable polyester film such that the intermediate heat shrinkage rate has a negative value in this way, wrinkles and the like in the case of using the film as a heat-shrinkable polyester film can be prevented more effectively.

Therefore, it is more preferable that the minimum value of the intermediate heat shrinkage rate is −1.5 mm/sec or more, and even more preferably 0 mm/sec or more.

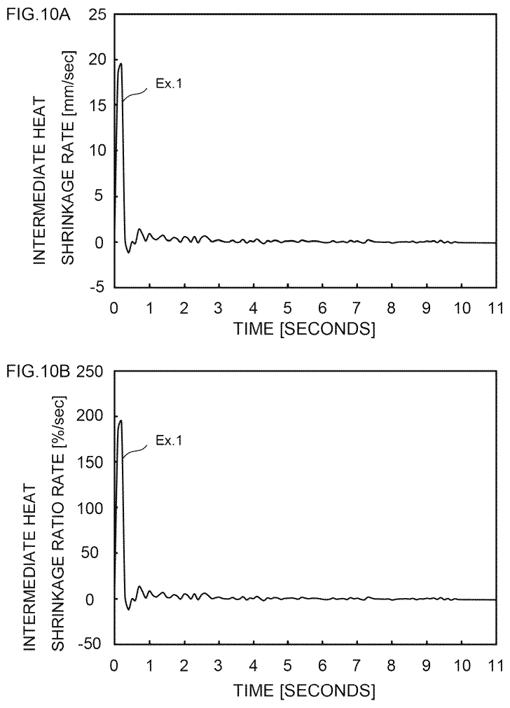

Here, referring to FIG. 10A to FIG. 13A, the relation between the time (seconds) and the intermediate heat shrinkage rate (mm/sec) will be described.

Specifically, for Examples 1 and 2 and Comparative Examples 2 and 3 that will be described below, the time (seconds) was plotted on the axis of abscissa, the maximum value of the intermediate heat shrinkage rate (mm/sec) of predetermined sections provided at six locations at intervals of 10 mm along the main shrinkage direction was plotted on the axis of ordinate, and measurements were made at intervals of 0.1 seconds and graphed.

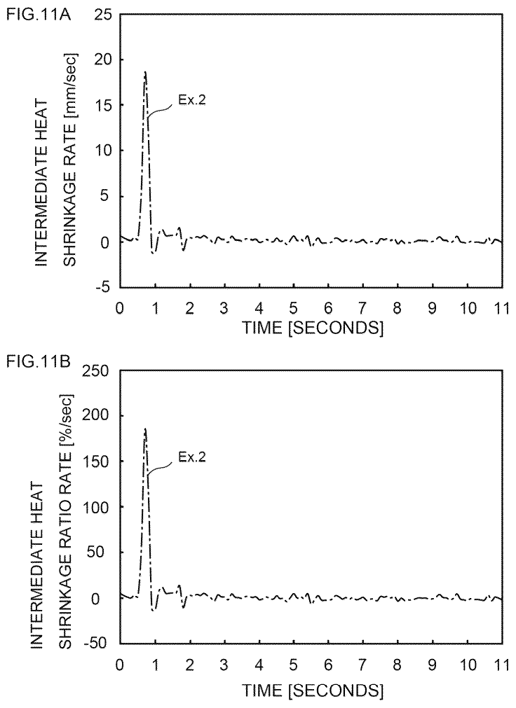

According to such FIG. 10A to FIG. 11A, it can be seen that in Example 1 and Example 2, the intermediate heat shrinkage rate reaches the maximum value between 0 seconds and 1 second, and decreases to about 0 mm/sec after a lapse of 1 second from the start point of heat shrinkage.

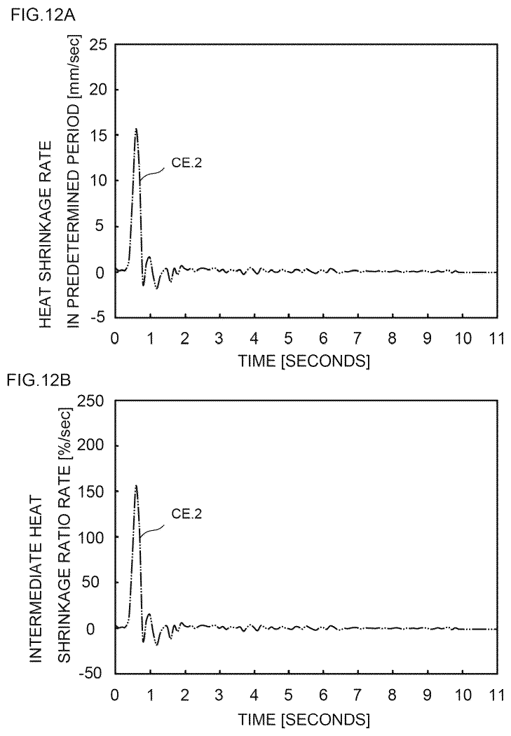

On the other hand, according to FIG. 12A, it can be seen that in Comparative Example 2, the intermediate heat shrinkage rate reaches the maximum value between 0 seconds and 1 second, but between 1 second and 2 seconds thereafter, the intermediate heat shrinkage rate varies greatly with 0 mm/sec as a limit.

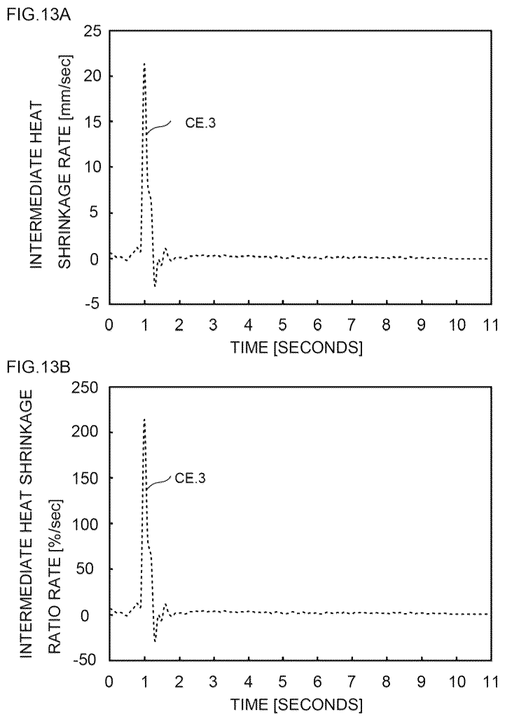

In addition, according to FIG. 13A, it can be seen that in Comparative Example 3, the intermediate heat shrinkage rate is 5 mm/sec or less between 0 seconds and 1 second, increases to above 20 mm/sec after a lapse of about 1 second, and thereafter decreases to 5 mm/sec or less between 1.1 seconds and 1.5 seconds.

Incidentally, in the case of FIG. 10B to FIG. 13B, a heat shrinkage rate of 1 mm/sec corresponds to a heat shrinkage ratio rate of 10%/sec.

### (5) Standard Deviation of Maximum Value of Intermediate Heat Shrinkage Rate

Furthermore, with regard to the heat-shrinkable polyester film, when a plurality of predetermined sections are provided, and the intermediate heat shrinkage rate for each of the predetermined sections from the start point of heat shrinkage to a predetermined time t1 is determined at every 0.1 seconds, it is preferable that the standard deviation of the maximum value of the intermediate heat shrinkage rate for each predetermined section is 4.5 mm/sec or less.

The reason for this is that, by adopting such a standard deviation, the shrinkage ratio within a predetermined time during heat shrinkage can be adjusted precisely, and the behavior during heat shrinkage is further stabilized.

Therefore, it is more preferable that the standard deviation of the maximum value of the intermediate heat shrinkage rate is 3.5 mm/sec or less, and even more preferably 3 mm/sec or less.

Incidentally, the standard deviation is the square root of the sum of the squares of deviations divided by the value of (number of data points −1).

### (6) Heat Shrinkage Ratio Rate in Predetermined Period (Intermediate Heat Shrinkage Ratio Rate)

Furthermore, when the heat-shrinkable polyester film is caused to undergo heat shrinkage at a predetermined temperature T for a predetermined time t1 as shown in FIG. 6B, it is preferable that the intermediate heat shrinkage ratio rate in the main shrinkage direction (hereinafter, sometimes referred to as intermediate heat shrinkage ratio rate) is 200%/sec or less, as calculated based on the following Formula (5) from the distance change between a distance PL0 of a predetermined section before heat shrinkage, a distance PL1 of the predetermined section at a predetermined time t2, which is shorter than the predetermined time t1, and a distance PL2 of the predetermined section at a predetermined time t3, which is shorter than the predetermined time t1 and longer than the predetermined time t2.

$$Intermediate heat shrinkage ratio rate ( \% / sec ) = ( PL 1 - PL 2 ) / ( PL 0 \times ( t 3 - t 2 ) ) \times 100 \qquad ( 5 )$$

The reason for this is that, by adopting such an intermediate heat shrinkage ratio rate, the heat shrinkage rate of the heat-shrinkable polyester film can be adjusted more precisely irrespective of the size of the heat-shrinkable polyester film.

Therefore, it is more preferable that the intermediate heat shrinkage ratio rate is 180%/sec or less, and even more preferably 150%/sec or less.

On the other hand, from the viewpoint of preventing defects caused by excessively small shrinkage in a short period of time, it is preferable that the intermediate heat shrinkage ratio rate is 608/sec or more, more preferably 80%/sec or more, and even more preferably 90%/sec or more.

Incidentally, it is preferable that the intermediate heat shrinkage ratio rate always has a positive value in the same manner as for the intermediate heat shrinkage rate; however, it has been found that even in a case where the intermediate heat shrinkage ratio rate has a negative value, there is no problem with the intended use of the heat-shrinkable polyester film so long as the value is small.

Therefore, with regard to the heat-shrinkable polyester film, it is preferable that the minimum value of the intermediate heat shrinkage ratio rate is suppressed to be −2.5%/sec or more.

It is because, by suppressing the behavior of the heat-shrinkable polyester film such that the intermediate heat shrinkage ratio rate has a negative value in this way, wrinkles and the like in the case of using the film as a heat-shrinkable polyester film can be prevented more effectively.

Therefore, it is more preferable that the minimum value of the intermediate heat shrinkage ratio rate is −1.5%/sec, and even more preferably 0%/sec or more.

Furthermore, upon calculating the heat shrinkage ratio rate, it is preferable to set the predetermined times t2 and t3 to be 5 seconds or less.

The reason for this is that, by adopting such a predetermined time, the behavior of the heat-shrinkable polyester film during heat shrinkage can be measured in more detail.

Therefore, it is more preferable that the predetermined times t2 and t3 to be 4 seconds or less, and even more preferably 3 seconds or less.

Furthermore, it is preferable that the time in which the intermediate heat shrinkage ratio rate becomes maximum is 1 second or less.

The reason for this is that, by configuring the heat-shrinkable polyester film in this way, the timing at which the heat-shrinkable polyester film significantly shrinks can be controlled, and the heat shrinkage characteristics can be adjusted more precisely.

Therefore, it is more preferable that the time at which the intermediate heat shrinkage ratio rate becomes maximal is 0.8 seconds or less, and even more preferably 0.6 seconds or less.

### (7) Difference in Heat Shrinkage Ratio Rate Per Second

Furthermore, with regard to the heat-shrinkable polyester film, when a predetermined section is provided along the main shrinkage direction of the heat-shrinkable polyester film, and the film is caused to undergo heat shrinkage along the main shrinkage direction at a predetermined temperature T for a predetermined time t1, when the distance of the predetermined section before heat shrinkage is PL0, the distance of the predetermined section at a predetermined time t2, which is shorter than the predetermined time t1, is PL1, the distance of the predetermined section at a predetermined time t3, which is shorter than the predetermined time t1 and longer than the predetermined time t2, is PL2, and the measurement time t3−t2 is 1 second, it is preferable that the difference in the heat shrinkage ratio rate per second calculated based on the following Formula (6) is usually 100%/sec or less under predetermined conditions (predetermined temperature T: 70° C. to 98° C., predetermined time t1: above 5 seconds).

$$\begin{matrix}Difference in heat shrinkage ratio rate per second ( \% / sec ) = ( PL 0 - PL 1 ) / ( PL 0 \times t 2 ) \times 100 \\ = ( PL 0 - PL 2 ) / ( PL 0 \times t 3 ) \times 100\end{matrix} \qquad ( 6 )$$

The reason for this is that, by taking such a difference in the heat shrinkage ratio rate, the heat-shrinkable polyester film can be caused to shrink more stably.

Therefore, it is more preferable that the difference in the heat shrinkage ratio rate is 80%/sec or less, and even more preferably 50%/sec or less.

### 9. Other Examination Steps

That is, it is preferable that predetermined examination steps are provided to measure the following characteristics and the like continuously or intermittently for the produced heat-shrinkable polyester film.

That is, by measuring the following characteristics and the like through such predetermined examination steps, and checking whether the characteristics and the like have values within predetermined ranges, a heat-shrinkable polyester film having more uniform shrinkage characteristics and the like can be obtained.
1) Examination by visual inspection of the appearance of the heat-shrinkable polyester film
2) Measurement of variation in thickness
3) Measurement of tensile modulus
4) Measurement of tear strength
5) Measurement of viscoelastic characteristics using SS curve
6) Thermal characteristics (TD direction, MD direction)
7) Heat shrinkage stress
8) Stretch ratio

### Second Embodiment

A second embodiment is an embodiment related to a method of using a heat-shrinkable polyester film whose heat shrinkage ratio has been measured using a motion capture device.

Therefore, that is, any known method of using a heat-shrinkable film can all be suitably applied.

For example, when carrying out the method of using a heat-shrinkable polyester film, first, the heat-shrinkable polyester film is cut to an appropriate length or width, and at the same time, a long cylindrical-shaped object is formed.

Next, the long cylindrical-shaped object is fed to an automatic label attaching apparatus (shrink labeler), cut to a required length.

Next, the long cylindrical-shaped object is fitted onto the outside of a PET bottle or the like filled with contents.

Next, as a heating treatment of the heat-shrinkable polyester film fitted onto the outside of a PET bottle or the like, the heat-shrinkable polyester film is passed through the inside of a hot air tunnel or a steam tunnel at a predetermined temperature.

Then, the heat-shrinkable polyester film is uniformly heated and caused to undergo heat shrinkage, by radiating radiant heat such as infrared rays provided by these tunnels, or blowing heated steam at about 90° C. from the surroundings.

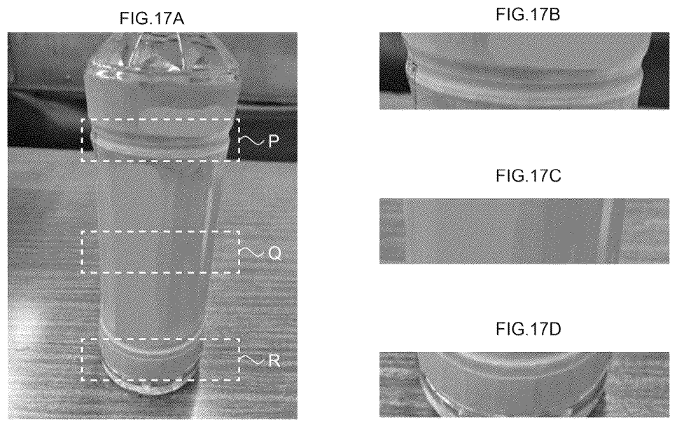

Therefore, when the heat shrinkage ratio in the TD direction is 20% or more, as shown in FIGS. 17A to 17D, a labeled container can be quickly obtained by adhering the heat-shrinkable polyester film tightly to the outer surface of a PET bottle or the like.

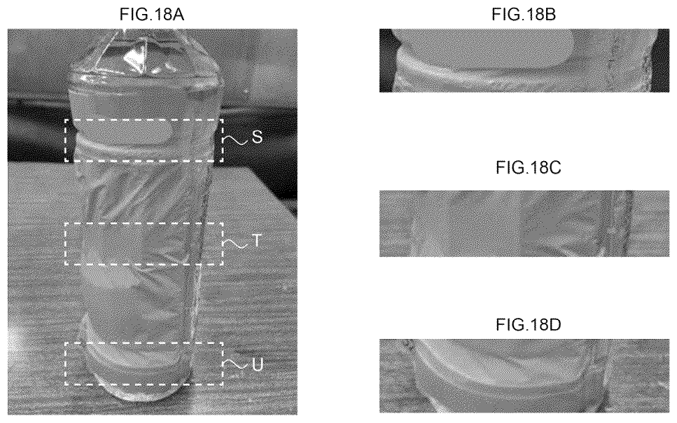

On the other hand, when the heat shrinkage ratio in the TD direction is below 20%, as shown in FIGS. 18A to 18D, regions where the label could not follow the shape of the bottle periphery occur from the top to the bottom of the bottle body, and the occurrence of wrinkles is also noticeably observed.

### EXAMPLES

Hereinafter, the present invention will be described in detail based on Examples. However, the scope of rights of the present invention will not be narrowed by the description of Examples without any particular reason.

Furthermore, the polyester resins used in Example 1 and the like are as follows.

### PETG1

A non-crystalline polyester composed of dicarboxylic acid: 100 mol % of terephthalic acid, diol: 69 mol % of ethylene glycol, 20 mol % of 1,4-cyclohexanedimethanol, and 11 mol % of diethylene glycol (glass transition point: 69° C.)

### PETG2

A non-crystalline polyester composed of dicarboxylic acid: 100 mol % of terephthalic acid, diol: 63 mol % of ethylene glycol, 24 mol % of 1,4-cyclohexanedimethanol, and 13 mol % of diethylene glycol (glass transition point: 69° C.)

### PETG3

A non-crystalline polyester composed of dicarboxylic acid: 100 mol % of terephthalic acid, diol: 68 mol % of ethylene glycol, 30 mol % of neopentyl glycol, and 2 mol % of diethylene glycol (glass transition point: 75° C.)

### PETG4

A non-crystalline polyester composed of dicarboxylic acid: 100 mol % of terephthalic acid, diol: 70 mol % of ethylene glycol, 28 mol % of 1,4-cyclohexanedimethanol, and 2 mol % of diethylene glycol (glass transition point: 69° C.)

### Example 1

### 1. Production of Heat-Shrinkable Polyester Film

A non-crystalline polyester resin (PETG1) was used at a proportion of 100 parts by weight (pbw) in a stirring container.

Next, this raw material was dried into an absolute dry state and then subjected to extrusion molding under the condition of an extrusion temperature of 260° C. by using an extruder (manufactured by Tanabe Plastics Machinery Co., Ltd.) with an L/D ratio of 24 and an extrusion screw diameter of 50 mm, to obtain a raw sheet having a thickness of 200 μm.

Next, a heat-shrinkable polyester film having a thickness of 40 μm was produced from the raw sheet by using a heat-shrinkable film manufacturing apparatus, at a preheating temperature of 75° C., a stretching temperature of 75° C., stretch ratios (MD direction: 105%, TD direction: 500%), and a thermal fixing temperature of 60° C.

### 2. Evaluation of Heat-Shrinkable Polyester Film

### (1) Evaluation 1: Variation in Thickness

The thickness (a desired value of 50 μm was taken as a reference value) of the obtained heat-shrinkable polyester film was measured (n=6) using a micrometer and evaluated according to the following criteria as EVA 1.

⊙ (Very good): The variation in thickness has a value of 3 μm or less.

◯ (Good): The variation in thickness has a value of 5 μm or less.

Δ (Fair): The variation in thickness has a value of 10 μm or less.

× (Bad): The variation in thickness has a value of above 10 μm.

### (2) Evaluation 2: Heat Shrinkage Ratio in TD Direction (A1)

The obtained heat-shrinkable polyester film was immersed in hot water at 95° C. for 1 second by using a hot water bath to cause the film to undergo heat shrinkage.

Next, as shown in FIG. 2A, the heat shrinkage ratio in the TD direction (A1) was calculated from a distance change of markers obtained before and after a heating treatment using an image-type motion capture device 14 according to Formula (1) while capturing image data with an optical camera, and the heat shrinkage ratio was evaluated according to the following criteria as EVA 2.

⊙ (Very good): The heat shrinkage ratio (A1) has a value within the range of 50% to below 85%.

◯ (Good): The heat shrinkage ratio (A1) has a value of 30% to below 50%, or 85% to below 90%.

Δ (Fair): The heat shrinkage ratio (A1) has a value of 20% to below 30%, or 90% to below 95%.

× (Bad): The heat shrinkage ratio (A1) has a value of below 20% or above 95%.

### (3) Evaluation 3: Standard Deviation (σ1) of Heat Shrinkage Ratio in TD Direction (A1)

The standard deviation (σ1) was calculated from the values (n=6) of the heat shrinkage ratio in the TD direction (A1) obtained in Evaluation 2 using a motion capture device of image type, and was evaluated according to the following criteria as EVA 3.

⊙ (Very good): The standard deviation of the heat shrinkage ratio (A1) is 5% or less.

◯ (Good): The standard deviation of the heat shrinkage ratio (A1) is 10% or less.

Δ (Fair): The standard deviation of the heat shrinkage ratio (A1) is 15% or less.

× (Bad): The standard deviation of the heat shrinkage ratio (A1) is above 20%.

### (4) Evaluation 4: Heat Shrinkage Ratio in TD Direction (A′1)

The obtained heat-shrinkable polyester film was immersed in hot water at 95° C. for 10 seconds by using a hot water bath to cause the film to undergo heat shrinkage. Next, a dimensional change before and after a heating treatment were calculated based on the data, and the heat shrinkage ratio in the TD direction (A′1) was calculated according to Formula (1) and evaluated according to the following criteria as EVA 4.

⊙ (Very good): The heat shrinkage ratio (A′1) has a value within the range of 70% to 85%.

◯ (Good): The heat shrinkage ratio (A′1) has a value of 65% to below 70%, or 85% to below 90%.

Δ (Fair): The heat shrinkage ratio (A′1) has a value of 60% to below 65%, or 90% to below 95%.

× (Bad): The heat shrinkage ratio (A′1) has a value of below 60% or above 95%.

### (5) Evaluation 5: Haze Value

For the obtained heat-shrinkable polyester film, the haze value was measured according to JIS K 7136:2000 and evaluated according to the following criteria.

⊙ (Very good): The haze value is 3% or less.

◯ (Good): The haze value is 5% or less.

Δ (Fair): The haze value is 7% or less.

× (Bad): The haze value is above 7%.

### (6) Evaluation 6: Heat Shrinkage Ratio in TD Direction (A2)

The obtained heat-shrinkable polyester film was immersed in hot water at 80° C. for 1 second by using a hot water bath to cause the film to undergo heat shrinkage.

Next, as shown in FIG. 2A, the heat shrinkage ratio in the TD direction (A2) was calculated from a distance change of markers obtained before and after a heating treatment using an image-type motion capture device 14 according to Formula (1) while capturing image data with an optical camera, and the heat shrinkage ratio was evaluated according to the following criteria as EVA 6.

⊙ (Very good): The heat shrinkage ratio (A2) has a value within the range of 20% to below 50%.

◯ (Good): The heat shrinkage ratio (A2) has a value of 15% to below 20%, or 50% to below 70%.

Δ (Fair): The heat shrinkage ratio (A2) has a value of 10% to below 15%, or 70% to below 80%.

× (Bad): The heat shrinkage ratio (A2) has a value of below 10% or above 80%.

### (7) Evaluation 7: Standard Deviation (σ2) of Heat Shrinkage Ratio in TD Direction (A2)

The standard deviation (σ2) was calculated from the values (n=6) of the heat shrinkage ratio in the TD direction (A2) obtained in Evaluation 6 using an image-type motion capture device, and was evaluated according to the following criteria as EVA 7.

⊙ (Very good): The standard deviation of the heat shrinkage ratio (A2) is 4% or less.

◯ (Good): The standard deviation of the heat shrinkage ratio (A2) is 8% or less.

Δ (Fair): The standard deviation of the heat shrinkage ratio (A2) is 12% or less.

× (Bad): The standard deviation of the heat shrinkage ratio (A2) is above 16%.

### (8) Evaluation 8: Heat Shrinkage Ratio in TD Direction (A′2)

The obtained heat-shrinkable polyester film was immersed in hot water at 80° C. for 10 seconds by using a hot water bath to cause the film to undergo heat shrinkage.

Next, as shown in FIG. 2A, the heat shrinkage ratio in the TD direction (A′2) was calculated from a distance change of markers obtained before and after a heating treatment using an image-type motion capture device 14 according to Formula (1) while capturing image data with an optical camera, and the heat shrinkage ratio was evaluated according to the following criteria as EVA 8.

⊙ (Very good): The heat shrinkage ratio (A′2) has a value within the range of 30% to below 65%.

◯ (Good): The heat shrinkage ratio (A′2) has a value of 20% to below 30%, or 65% to below 75%.

⊙ (Fair): The heat shrinkage ratio (A′2) has a value of 10% to below 20%, or 75% to below 85%.

× (Bad): The heat shrinkage ratio (A′2) has a value of below 10% or above 85%.

### (9) Evaluation 9: Standard Deviation (σ′2) of Heat Shrinkage Ratio in TD Direction (A′2)

The standard deviation (σ′2) was calculated from the values (n=6) of the heat shrinkage ratio in the TD direction (A′2) obtained in Evaluation 8 using an image-type motion capture device, and was evaluated according to the following criteria as EVA 9.

⊙ (Very good): The standard deviation of the heat shrinkage ratio (A′2) is 2.5% or less.

◯ (Good): The standard deviation of the heat shrinkage ratio (A′2) is 5% or less.

Δ (Fair): The standard deviation of the heat shrinkage ratio (A′2) is 7.5% or less.

× (Bad): The standard deviation of the heat shrinkage ratio (A′2) is above 10%.

### (10) Evaluation 10: Heat Shrinkage Rate

The obtained heat-shrinkable polyester film was floated on hot water at 80° C. for 10 seconds by using a hot water bath and was caused to undergo heat shrinkage while being measured for 10 seconds or more using an image-type motion capture device.

That is, the heat shrinkage rate in the main shrinkage direction was calculated according to Formula (2) from a distance change of predetermined markers before and after a predetermined time obtained using an image-type motion capture device while capturing image data with an optical camera, and the heat shrinkage rate was evaluated according to the following criteria as EVA 10.

At this time, upon calculating the heat shrinkage rate, the distance PL0 of a predetermined section before heat shrinkage was 10 mm, and measurements were made at intervals of 0.1 seconds.

⊙ (Very good): The heat shrinkage rate is 4 mm/sec or more.

◯ (Good): The heat shrinkage rate is 3 mm/sec or more and below 4 mm/sec.

Δ (Fair): The heat shrinkage rate is 2 mm/sec or more and below 3 mm/sec.

× (Bad): The heat shrinkage rate is below 2 mm/sec.

### (11) Evaluation 11: Minimum Value of Intermediate Heat Shrinkage Rate

The obtained heat-shrinkable polyester film was floated on hot water at 80° C. for 10 seconds by using a hot water bath to cause the film to undergo heat shrinkage.

Next, the intermediate heat shrinkage rate was determined according to Formula (4) from the heat shrinkage ratios (number of predetermined sections n=6) in the main shrinkage direction obtained using an image-type motion capture device while capturing image data with an optical camera, and from the minimum value of the intermediate heat shrinkage rate in the section with the largest maximum value of the intermediate heat shrinkage rate among the predetermined sections, the intermediate heat shrinkage rate was evaluated according to the following criteria as EVA 11.

At this time, upon calculating the intermediate heat shrinkage rate, the distance PL0 of a predetermined section before heat shrinkage was 10 mm, and measurements were made by taking the measurement period t3−t2 as 0.1 seconds.
⊙ (Very good): The minimum value of the intermediate heat shrinkage rate is 0 mm/sec or more.
◯ (Good): The minimum value of the intermediate heat shrinkage rate is −1.5 mm/sec or more.
Δ (Fair): The minimum value of the intermediate heat shrinkage rate is −2.5 mm/sec or more.
× (Bad): The minimum value of the intermediate heat shrinkage rate is below −2.5 mm/sec.

### Example 2

### 1. Production of Heat-Shrinkable Polyester Film

In Example 2, a raw sheet having a thickness of 200 μm was obtained in the same manner as in Example 1, except that 100 parts by weight of a non-crystalline polyester resin (PETG2) was used in a stirring container, as shown in Table 1.

Next, a heat-shrinkable polyester film having a thickness of 40 μm was produced from the raw sheet by using a heat-shrinkable film manufacturing apparatus, at a preheating temperature of 75° C., a stretching temperature of 75° C., stretch ratios (MD direction: 105%, TD direction: 500%), and a thermal fixing temperature of 60° C.

### 2. Evaluation of Heat-Shrinkable Polyester Film

In Example 2, the variation in thickness (Evaluation 1) of the obtained heat-shrinkable polyester film, the heat shrinkage ratio in the TD direction obtained using a motion capture device of image type (Evaluation 2 and Evaluation 4), the standard deviation of the heat shrinkage ratio in the TD direction obtained using a motion capture device of image type (Evaluation 3), and the like were measured and then evaluated in the same manner as in Example 1. The results are shown in Table 2 and Table 3.

### Comparative Example 1

### 1. Production of Heat-Shrinkable Polyester Film

In Comparative Example 1, a raw sheet having a thickness of 200 μm was obtained in the same manner as in Example 1, except that 50 parts by weight of a non-crystalline polyester resin (PETG3) and 50 parts by weight of a non-crystalline polyester resin (PETG4) were used in a stirring container, as shown in Table 1.

Next, a heat-shrinkable polyester film having a thickness of 40 μm was produced from the raw sheet by using a heat-shrinkable film manufacturing apparatus, at a preheating temperature of 90° C., a stretching temperature of 90° C., stretch ratios (MD direction: 105%, TD direction: 500%), and a thermal fixing temperature of 60° C.

### 2. Evaluation of Heat-Shrinkable Polyester Film

In Comparative Example 1, the variation in thickness (Evaluation 1) of the obtained heat-shrinkable polyester film, the heat shrinkage ratio in the TD direction obtained using a motion capture device of image type (Evaluation 2 and Evaluation 4), the standard deviation of the heat shrinkage ratio in the TD direction obtained using a motion capture device of image type (Evaluation 3), and the like were evaluated in the same manner as in Example 1. The results are shown in Table 2 and Table 3.

### Comparative Example 2

### 1. Production of Heat-Shrinkable Polyester Film

In Comparative Example 2, a raw sheet having a thickness of 200 μm was obtained in the same manner as in Example 1, except that 100 parts by weight of a non-crystalline polyester resin (PETG4) were used in a stirring container, as shown in Table 1.

Next, a heat-shrinkable polyester film having a thickness of 40 μm was produced from the raw sheet by using a heat-shrinkable film manufacturing apparatus, at a preheating temperature of 90° C., a stretching temperature of 90° C., stretch ratios (MD direction: 105%, TD direction: 500%), and a thermal fixing temperature of 60° C.

### 2. Evaluation of Heat-Shrinkable Polyester Film

In Comparative Example 2, the variation in thickness (Evaluation 1) of the obtained heat-shrinkable polyester film, the heat shrinkage ratio in the TD direction obtained using a motion capture device of image type (Evaluation 2 and Evaluation 4), the standard deviation of the heat shrinkage ratio in the TD direction obtained using a motion capture device of image type (Evaluation 3), and the like were evaluated in the same manner as in Example 1. The results are shown in Table 2 and Table 3.

### Comparative Example 3

### 1. Production of Heat-Shrinkable Polyester Film

In Comparative Example 3, a raw sheet having a thickness of 200 μm was obtained in the same manner as in Example 1, except that 100 parts by weight of a non-crystalline polyester resin (PETG3) were used in a stirring container, as shown in Table 1.

Next, a heat-shrinkable polyester film having a thickness of 40 um was produced from the raw sheet by using a heat-shrinkable film manufacturing apparatus, at an extrusion temperature of 260° C., a preheating temperature of 90° C., a stretching temperature of 90° C., stretch ratios (MD direction: 105%, TD direction: 500%), and a thermal fixing temperature of 60° C.

### 2. Evaluation of Heat-Shrinkable Polyester Film

In Comparative Example 3, the variation in thickness (Evaluation 1) of the obtained heat-shrinkable polyester film, the heat shrinkage ratio in the TD direction obtained using a motion capture device of image type (Evaluation 2 and Evaluation 4), the standard deviation of the heat shrinkage ratio in the TD direction obtained using a motion capture device of image type (Evaluation 3), and the like were evaluated in the same manner as in Example 1. The results are shown in Table 2 and Table 3.

TABLE 1

| | | | Conditions for stretching in TD direction | | | | |
|---|---|---|---|---|---|---|---|
| | | | | | | Thermal | Glass |
| | | Extrusion | Preheating | Stretch | Stretching | fixing | transition |
| | | temperature | temperature | ratio | temperature | temperature | point |
| | Resin | (° C.) | (° C.) | (%) | (° C.) | (° C.) | (° C.) |
| Example 1 | PETG1 | 260 | 75 | 500 | 75 | 60 | 69 |
| Example 2 | PETG2 | 260 | 75 | 500 | 75 | 60 | 69 |
| Comparative | PETG3 (50%) | 260 | 90 | 500 | 90 | 60 | 72 |
| Example 1 | PETG4 (50%) | | | | | | |
| Comparative | PETG4 | 260 | 90 | 500 | 90 | 60 | 69 |
| Example 2 | | | | | | | |
| Comparative | PETG3 | 260 | 90 | 500 | 90 | 60 | 75 |
| Example 3 | | | | | | | |

TABLE 2

| | EVA 1 | EVA 2 | EVA 3 | EVA 4 | EVA 5 |
|---|---|---|---|---|---|
| Example 1 | Very | Very | Very | Very | Very |
| | good | good | good | good | good |
| Example 2 | Good | Very | Very | Very | Good |
| | | good | good | good | |
| Comparative | Bad | Bad | Good | Fair | Very |
| Example 1 | | | | | good |
| Comparative | Bad | Bad | Good | Fair | Very |
| Example 2 | | | | | good |
| Comparative | Fair | Bad | Very | Good | Very |
| Example 3 | | | good | | good |

EVA 1: Variation in thickness,
EVA 2: A1,
EVA 3: σ1,
EVA 4: A′1,
EVA 5: Haze value

TABLE 3

| | EVA 6 | EVA 7 | EVA 8 | EVA 9 | EVA 10 | EVA 11 |
|---|---|---|---|---|---|---|
| Example 1 | Very | Very | Very | Very | Very | Good |
| | good | good | good | good | good | |
| Example 2 | Very | Very | Very | Very | Good | Good |
| | good | good | good | good | | |
| Comparative | Very | Good | Very | Very | Fair | Fair |
| Example 1 | good | | good | good | | |
| Comparative | Very | Good | Very | Very | Fair | Fair |
| Example 2 | good | | good | good | | |
| Comparative | Bad | Fair | Very | Very | Bad | Bad |
| Example 3 | | | good | good | | |

EVA 6: A2,
EVA 7: σ2,
EVA 8: A′2,
EVA 9: σ′2,
EVA 10: Heat shrinkage rate,
EVA 11: Minimum value of intermediate heat shrinkage rate

### INDUSTRIAL APPLICABILITY

According to the present invention, a heat-shrinkable polyester film and the like exhibiting excellent wrinkle resistance characteristics can be quickly and precisely evaluated and provided by limiting at least the heat shrinkage ratio and the like measured under predetermined conditions, to values within predetermined ranges using a motion capture device.

Therefore, the heat-shrinkable polyester film of the present invention can be applied to various PET bottles and the like, general-purpose usability can be markedly expanded, and it can be said that industrial applicability of the film is extremely high.

1. A method for measuring a heat shrinkage ratio in a main shrinkage direction of a heat-shrinkable polyester film by using a motion capture device, the method comprising the following steps (a) to (e):
step (a): a step of setting two measurement positions in a main shrinkage direction of the heat-shrinkable polyester film as an object to be measured, and measuring an interval between the two measurement positions as L1;
step (b): a step of providing a predetermined marker at each of the two measurement positions;
step (c): a step of heating the heat-shrinkable polyester film at a temperature for a time as predetermined heat shrinkage conditions to cause the film to undergo heat shrinkage;
step (d): a step of measuring a distance of the predetermined interval after heat shrinkage as L′1 by using a motion capture device; and
step (e): a step of calculating a heat shrinkage ratio in the main shrinkage direction of the heat-shrinkable polyester film based on the following Formula (1):
$$Heat shrinkage ratio in TD direction ( \% ) = ( L 1 - {L}^{′} 1 ) / L 1 \times 100. \qquad ( 1 )$$

2. The method for measuring a heat shrinkage of a heat-shrinkable polyester film according to claim 1, wherein the interval between two measurement positions in the step (a) is set at a plurality of sites, a plurality of heat shrinkage ratios in a TD direction are calculated in steps (d) and (e), and an average value thereof is defined as the heat shrinkage ratio in the TD direction.

3. The method for measuring a heat shrinkage ratio of a heat-shrinkable polyester film according to claim 1, wherein a motion capture device of image type is used as the motion capture device, and the heat shrinkage ratio in the TD direction is calculated based on positions of the predetermined markers before and after heat shrinkage.

4. The method for measuring a heat shrinkage ratio of a heat-shrinkable polyester film according to claim 1, wherein a camera is prepared in step (b), and a state of heat shrinkage of the heat-shrinkable polyester film as an object to be measured is also observed.

5. The method for measuring a heat shrinkage ratio of a heat-shrinkable polyester film according to claim 1, wherein a heat shrinkage temperature used in the step (c) has a value within a range of 50° C. to 98° C., and a heat shrinkage time has a value within a range of 1 to 60 seconds.

6. The method for measuring a heat shrinkage ratio of a heat-shrinkable polyester film according to claim 1, wherein a heat shrinking device used in step (c) is at least one of a constant temperature bath, a steam bath, a hot water bath, a fluorine-containing liquid bath, and an infrared ray irradiating apparatus.

7. The method for measuring a heat shrinkage ratio of a heat-shrinkable polyester film according to claim 1, wherein in the step (d), a heat shrinkage ratio in a direction orthogonally intersecting the main shrinkage direction of the heat-shrinkable polyester film as an object to be measured is measured as a heat shrinkage ratio in an MD direction by using the motion capture device, simultaneously with measurement of the heat shrinkage ratio in the TD direction.

8. The method for measuring a heat shrinkage ratio of a heat-shrinkable polyester film according to claim 1, further comprising, as step (f), a step of preparing in advance a calibration curve showing a relation between the heat shrinkage temperature and the heat shrinkage time in the main shrinkage direction of the heat-shrinkable polyester film as an object to be measured, and the heat shrinkage ratio in the TD direction, and comparing and verifying the calibration curve with the heat shrinkage ratio obtained based on Formula (1), after step (e).
